(19) United States
(12) Patent Application Publication
(10) Pub. No.: US 2025/0382470 A1
(43) Pub. Date: Dec. 18, 2025

(54) Expandable Foam Formulations, Expanded Foam Materials, and Methods of Making and Using the Same

(71) Applicant: CertainTeed LLC, Malvern, PA (US)

(72) Inventors: Nicholas David Orf, Natick, MA (US); Kapsoo Cheon, Marlborough, MA (US); Rachel Brown, Shrewsbury, MA (US); Choung-Houng` Lai, Acton, MA (US)

(21) Appl. No.: 18/880,153

(22) PCT Filed: Jun. 29, 2023
(86) PCT No.: PCT/US2023/026630

§ 371 Date: Dec. 30, 2024

Related U.S. Application Data
(60) Provisional application No. 63/367,333, filed on Jun. 30, 2022.

(51) Int. Cl. C09D 4/06; B29C 44/18; B29K 33/00; B29K 63/00; B29K 105/00; B29L 31/10; C09D 135/02; C09D 163/00

(52) U.S. Cl. CPC C09D 4/06; B29C 44/18; C09D 135/02; C09D 163/00; B29K 2033/12; B29K 2063/00; B29K 2105/0088; B29K 2995/0015; B29L 2031/10

(57) ABSTRACT

The present disclosure relates generally to materials and methods for providing expanded foam materials. In one aspect, the present disclosure provides an expandable foam formulation, the expandable foam formulation being expandable to provide an expanded foam material, the expandable foam formulation comprising: one or more (meth)acrylate and/or epoxy monomers, each selected from one or more (meth)acrylate monomers, one or more epoxy monomers, and one or more epoxy (meth)acrylate monomers, provided that if no epoxy (meth)acrylate monomer is present, both of one or more (meth)acrylate monomers and one or more epoxy monomers are present; one or more primary amines; and an optional blowing agent, wherein, if no epoxy (meth)acrylate monomer is present, two or more of a (meth)acrylate monomer, an epoxy monomer and a primary amine monomer are polyfunctional.

### CROSS-REFERENCE TO RELATED APPLICATIONS

This application claims the benefit of priority of U.S. Provisional Patent Application No. 63/367,333, filed Jun. 30, 2022, which is hereby incorporated by reference herein in its entirety.

### BACKGROUND OF THE DISCLOSURE

### 1. Field of the Disclosure

The present disclosure relates to expandable foam formulations, expanded foam materials, and methods of making and using the same. They can be used in a host of applications, for example, in insulating cavities such as building cavities.

### 2. Technical Background

Heating and cooling of buildings uses approximately 35% of all the energy consumed in the United States of America (USA). Thanks to numerous innovations in construction practices and materials used in new construction, new buildings use less than half the energy per square foot of older buildings. However, the number of new buildings built each year is only about 2% of the number of existing buildings. Since most buildings last for 50 years or more, it will take several generations before low energy new buildings begin to have a significant impact on the overall energy used by buildings in the USA. Thus there is an urgent national need for simple low cost retrofit energy saving technologies that can be applied to existing buildings to achieve energy use similar to new buildings.

The most common approach to reduce thermal energy use in existing buildings is “weatherization”. In a typical weatherization job, a contractor seals air leaks and adds additional blown in fibrous insulation to the attic of a building. Federal and state governments have invested billions of dollars in weatherization programs. However, most studies indicate that weatherization projects result in average energy savings of only 15% and don't come close to achieving the energy use levels of new buildings. A recent study of weatherization programs, conducted by MIT, the University of Chicago, and the University of California, concluded that the average annual return on government funded weatherization programs is −9%.

Another approach for reducing thermal energy use in buildings is a “deep energy retrofit”. As opposed to the 15% energy savings of a weatherization job, a deep energy retrofit of a building can reduce the thermal energy use by 30%-50% or more. Typical deep energy retrofits involve tearing off siding, resetting windows, reconfiguring roof eaves, fitting foam boards to the exteriors of the building, and replacing the siding. Because of the invasiveness of this process, the cost and time involved is very high. Typical time to complete a deep energy retrofit of a house is several months and often requires building occupants to vacate the building. Typical payback time is 25 years or more. Traditional deep energy retrofits are clearly not viable on a large scale.

Typical insulating materials used in building insulations include solid rigid foam insulating boards, fibrous insulation, and spray or injection foams. Rigid foam insulating boards are composed of small, individual cells separated from each other. The cellular material may be glass or foamed plastic, such as polystyrene, polyurethane, polyisocyanurate, polyolefin, and various elastomeric materials. Fibrous insulation is composed of small-diameter fibers, which finely divide the air space. Examples of fibrous insulation include fiberglass and mineral wool type insulations. Foam-in place insulation includes liquid foams that are sprayed, injected, or poured in place. In one example, spray or injection polyurethane foams a two-component mixture composed of isocyanate and polyol resin are mixed near the tip of a gun. The two most common methods of mixing are impingement mixing (a “high pressure” system), in which two streams of material impact each other under high pressure and static mixing (a “low pressure” system), in which the two streams of material are interlaced using a series of mixing elements. After ejection from the gun, the mixed partially expanded material forms an expandable foam that is sprayed onto roof tiles, concrete slabs, into wall cavities, or through holes drilled into a cavity of a finished wall. Once in place, the mixed foam fully expands. In closed-cell foam, the high-density cells are closed and filled with a gas that both enhances insulation value and helps the foam expand to fill the spaces around it. Open-cell foam cells are not as dense as the closed-cell foams and are filled with air, which gives the insulation a spongier texture.

Injection of open or closed cell foam into cavities within a building can achieve many of the same benefits of a traditional deep energy retrofit at costs that are at least an order of magnitude lower—and in days rather than months. Closed cell foam in particular offers many advantages over traditional fiberglass or cellulose insulation since it has twice the insulation value per inch and serves as both an air barrier and vapor barrier. Energy models of a house injected with closed cell foam indicate that thermal energy savings of 30%-50% can be achieved. A typical house can be injected in 3 days and the modeled payback time is 5 years or less.

In a typical liquid foam injection process, 4 or more holes are drilled on the interior or exterior of each cavity within the building, and then a 6″ tube is inserted into these holes and a shot of foam is injected and falls to the bottom of the cavity. After the foam has fully expanded and is tack free, a second shot can be injected above the first shot. Each layer of foam is called a “lift”. A typical 14.5″ wide×8′ high cavity is filled with 3 to 4 lifts of foam. As the foam cures within the cavity, it heats up in an exothermic reaction. Heated foam can be easily seen from the outside of the cavity with an infrared camera, and voids within the foam can be identified and corrected with additional shots of foam.

Many conventional foam materials injected into building cavities are based on well-known polyurethane chemistry, in which a mixture of polyisocyanate and a polyol are injected with a foaming agent and reacted in place to provide a polyurethane foam. Polyurethanes have many advantages. Polyurethane chemistry is, of course, a robust and adaptable system that can be applied to a great variety of applications, including insulation foams. Though the chemistry can flexibly provide a variety of different foam properties, the isocyanate precursor has a high potential for sensitization and severe allergic reaction, and so worker exposure is of increasing concern. This is especially the case in field-applied insulation foam situations, where despite well-developed safety instructions based on best available knowledge, the full adoption of such guidance by individual contractors cannot be controlled by suppliers.

In order to further reduce worker risk, there is great interest in developing isocyanate-free chemistries for future generations of injection foams. It is, though, a great technical and almost contradictory challenge to develop chemistries that are highly reactive and quickly polymerizable at room temperature yet benign and low-reactivity from a health and safety perspective. There is a need for new materials to address these challenges.

### SUMMARY OF THE DISCLOSURE

In one aspect, the present disclosure provides an expandable foam formulation, the expandable foam formulation being expandable to provide an expanded foam material, the expandable foam formulation comprising:
one or more (meth)acrylate and/or epoxy monomers, each selected from
   one or more (meth)acrylate monomers,
   one or more epoxy monomers, and
   one or more epoxy (meth)acrylate monomers,
   provided that if no epoxy (meth)acrylate monomer is present, both of one or more (meth)acrylate monomers and one or more epoxy monomers are present;
one or more primary amine monomers; and
optionally, a blowing agent,
   wherein, if no epoxy (meth)acrylate monomer is present, two or more of a (meth)acrylate monomer, an epoxy monomer and a primary amine monomer are polyfunctional.

In another aspect, the present disclosure provides a method for making an expanded foam material, the method comprising
providing an expandable foam formulation comprising
   one or more (meth)acrylate and/or epoxy monomers, each selected from
      one or more (meth)acrylate monomers,
      one or more epoxy monomers, and
      one or more epoxy (meth)acrylate monomers,
      provided that if no epoxy (meth)acrylate monomer is present, both of one or more (meth)acrylate monomers and one or more epoxy monomers are present;
   one or more primary amines;
wherein, if no epoxy (meth)acrylate monomer is present, two or more of a (meth)acrylate monomer, an epoxy monomer and a primary amine monomer are polyfunctional;
expanding the foam formulation by providing gas bubbles in the expandable foam formulation to provide an expanded foam formulation; and
curing the expanded foam formulation.

In another aspect, the present disclosure provides a method for forming an expanded foam material, the method comprising causing the expandable foam formulation as described herein to expand and cure to form the expanded foam material. The expansion can be caused by the action of a blowing agent, or in other embodiments by agitating the expandable foam formulation or combining it with a stream of gas.

Another aspect of the disclosure provides a method for providing a cavity with an expanded foam material, the cavity being enclosed by one or more walls including a first wall, the method comprising causing the expandable foam formulation as described herein to expand and cure to form the expanded foam material in the cavity.

Another aspect of the disclosure is an expanded foam material that is the expanded and cured product of an expandable foam formulation as described herein.

Another aspect of the disclosure is an expanded foam material made by a method as described herein.

Another aspect of the disclosure is a cavity enclosed by one or more walls, the cavity having an expanded foam material as described herein.

Another aspect of the disclosure is a kit for the provision of the expandable foam formulation as described herein by the mixing of a first part with a second part, wherein the kit comprises
a first part comprising all of the one or more (meth)acrylate monomers and all of the one or more epoxy monomers of the expandable foam formulation; and
a second part comprising all of the primary amine monomers of the expandable foam formulation,
wherein the first and second parts together comprise all components of the expandable foam formulation.

Additional aspects of the disclosure will be evident from the disclosure herein.

### BRIEF DESCRIPTION OF THE DRAWINGS

The accompanying drawings are included to provide a further understanding of the methods and devices of the disclosure, and are incorporated in and constitute a part of this specification. The drawings are not necessarily to scale, and sizes of various elements may be distorted for clarity. The drawings illustrate one or more embodiment(s) of the disclosure, and together with the description serve to explain the principles and operation of the disclosure.

FIG. 1 is a schematic view of a cavity (here, a building cavity) and a method for providing the cavity with an expanded foam material according to various embodiments of the disclosure.

FIG. 2 is a set of pictures of test foams of Example 1.

FIG. 3 is a set of pictures of test foams of Example 1.

FIG. 4 is a graph of foam height vs. time for and FIG. 5 is a picture of test foams of Example 1.

FIG. 6 is a graph of foam height vs. time for test foams of Example 2.

FIG. 7 is a graph of foam height vs. time for test foams of Example 2.

FIG. 8 provides graphs of foam height and pressure vs. time data for test foams of Example 2.

FIG. 9 provides foam height data for test foams of Example 3.

FIG. 10 provides rise time data for test foams of Example 3.

FIG. 11 provides graphs of foam height, pressure and temperature as a function of time for foams of Example 4 of the disclosure.

### DETAILED DESCRIPTION

The present inventors have developed an expandable foam formulation that can provide foams with a variety of properties and is rapid-curing at ambient temperature without the need for free radical initiation, and thus is suitable for a variety of applications. The expandable foam formulation need not include isocyanate and thus has an improved health and safety profile. Moreover, reactants can be selected to provide wide flexibility in material properties and health and safety profiles.

Accordingly, one aspect of the disclosure is an expandable foam formulation, the expandable foam formulation being expandable and curable to provide an expanded foam material, the expandable foam formulation comprising:
one or more (meth)acrylate and/or epoxy monomers, each selected from
   one or more (meth)acrylate monomers,
   one or more epoxy monomers, and
   one or more epoxy (meth)acrylate monomers,
   provided that if no epoxy (meth)acrylate monomer is present, both of one or more (meth)acrylate monomers and one or more epoxy monomers are present;
one or more primary amine monomers; and
optionally, a blowing agent,
   wherein, if no epoxy (meth)acrylate monomer is present, two or more of a (meth)acrylate monomer, an epoxy monomer and a primary amine monomer are polyfunctional.

Without intending to be bound by theory, the inventors surmise that the crosslinking of the expandable formulation to provide polymer proceeds generally as shown in the example scheme below:

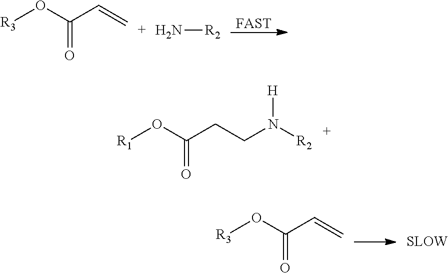

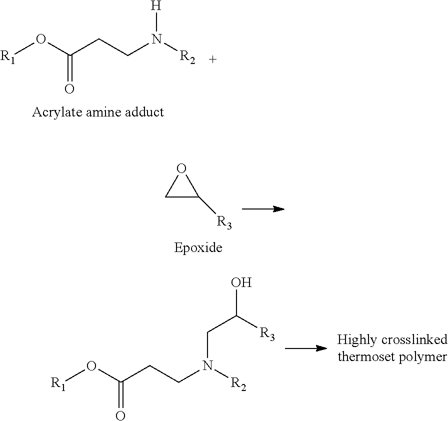

The Michael addition between primary amine and a first equivalent of (meth)acrylate (in the scheme, shown as an acrylate) is fast. However, Michael addition of the (meth)acrylate-amine adduct with a second equivalent of (meth)acrylate is slow. The reaction of the (meth)acrylate-amine adduct with an epoxide, however, is fast. Where two or more of the (meth)acrylate, the primary amine, and the epoxide are multifunctional (i.e., respectively having at least two (meth)acrylate functionalities, at least two primary amine functionalities, and at least two epoxide functionalities), a crosslinked polymer is formed.

As used herein, the term “monomer” encompasses any compound reactive in the crosslinking reaction, i.e., epoxies, (meth)acrylates and primary amines, regardless of molecular weight. Accordingly, a “monomer” may be a relatively small molecule, or may be oligomeric or even polymeric in size.

A wide variety of (meth)acrylate components can be used in the materials of the disclosure. The person of ordinary skill in the art will select desirable (meth)acrylate monomers, for example of desirable chain lengths and flexibilities, to provide desirable properties, e.g., desirable mechanical properties, to the final crosslinked polymer.

For example, in various desirable embodiments as otherwise described herein, the one or more (meth)acrylate monomers include one or more polyfunctional (meth)acrylate monomers. When one or more polyfunctional (meth)acrylate monomers are provided, they can act to crosslink the final cured material. The person of ordinary skill in the art will appreciate that the degree of functionality of the polyfunctional (meth)acrylate will impact the crosslink density of the polymer. In various embodiments, the one or more (meth)acrylate monomers comprise at least one trifunctional (meth)acrylate monomer. In various embodiments, the one or more (meth)acrylate monomers comprise a difunctional (meth)acrylate monomer, a trifunctional (meth)acrylate monomer, a tetrafunctional (meth)acrylate monomer, and/or a pentafunctional (meth)acrylate monomer. However, in some embodiments, a monofunctional (meth)acrylate monomer can be included to modify polymer properties without substantial crosslinking. The monofunctional (meth)acrylate monomer can be provided together with a polyfunctional (meth)acrylate monomer, or, in cases where a polyfunctional primary amine monomer and a polyfunctional epoxide monomer are provided, in the absence of a polyfunctional (meth)acrylate monomer.

The person of ordinary skill in the art will appreciate that the molecular weight of a polyfunctional (meth)acrylate monomer will also impact the crosslink density of a polymer. And the chain length of a monofunctional (meth)acrylate monomer will affect overall material properties. The person of ordinary skill in the art can, based on the present disclosure, select a desired molecular weight of the (meth)acrylate monomer component(s). For example, in various embodiments as described herein, at least one of (e.g., each of) the one or more (meth)acrylate monomers has a weight-average molecular weight in the range of 170 g/mol to 2000 g/mol, e.g., in the range of 170-1500 g/mol, or 170-1000 g/mol, or 170-700 g/mol, or 250-2000 g/mol, or 250-1500 g/mol, or 250-1000 g/mol, or 250-700 g/mol. Such molecular weights, when provided in polyfunctional (meth)acrylate monomers, can provide for relatively high crosslink densities and associated material properties. However, in some embodiments, higher-molecular weight materials can be provided; for example, in various embodiments as otherwise described herein, at least one of (e.g., each of) the one or more (meth)acrylate monomers has a weight-average molecular weight in the range of 2,000 g/mol to 200,000 g/mol, e.g., in the range of 2,000-100,000 g/mol, or 2,000-50,000 g/mol, or 2,000-20,000 g/mol, or 10,000-200,000 g/mol, or 10,000-100,000 g/mol, or 10,000-50,000 g/mol, or 20,000-200,000 g/mol.

A wide variety of (meth)acrylate monomers are suitable for use in the materials and methods of the present disclosure, depending on the desired properties of the final cured material. For example, in various embodiments as otherwise described herein, the one or more (meth)acrylate monomers include one or more of trimethylolpropane tri(meth)acrylate; ethylene glycol di(meth)acrylate; 1,6-hexanedioldi(meth)acrylate; pentaerythritol tetra(meth)acrylate; 3-methyl-1,5-pentanediol di(meth)acrylate; dipentaerythritol penta(meth)acrylate; and various bisphenol di(meth)acrylates such as bisphenol A di(meth)acrylate.

Other suitable (meth)acrylate monomers include polyether poly(meth)acrylates like di(ethylene glycol) di(meth)acrylate, tri(ethylene glycol) di(meth)acrylate, poly(ethylene glycol) di(meth)acrylate, poly(propylene glycol) di(meth)acrylate and poly(ethylene glycol-co-propylene glycol) di(meth)acrylate; polyester poly(meth)acrylates (e.g., in which the polyester is obtained by reacting a polyhydric alcohol (e.g. ethylene glycol, a polyethylene glycol, propylene glycol, a polypropylene glycol, tetramethylene glycol, a polytetramethylene glycol, 1,6-hexanediol, neopentyl glycol, 1,4-cyclohexane dimethanol, 3-methyl-1,5-pentanediol, 1,9-nonanediol, and 2-methyl-1,8-octanediol) with a polybasic acid (e.g., phthalic acid, isophthalic acid, terephthalic acid, maleic acid, fumaric acid, adipic acid, and sebacic acid)); and silicone poly(meth)acrylates.

In some embodiments, the one or more (meth)acrylate monomers includes one or more urethane poly(meth)acrylate monomers and/or one or more urea poly(meth)acrylate monomers. While urethanes and ureas are synthesized using isocyanates, the materials themselves can be provided with sufficiently low amounts of residual isocyanate so as not to pose a significant health and safety risk. Various types of urethane (meth)acrylate monomers are commercially available, such as: CN 975 (hexafunctional aromatic urethane acrylate oligomer from Sartomer); CN9001 (aliphatic urethane acrylate from Sartomer); ether-type urethane diacrylate oligomer (from Wuxi Tianjiao-saite Co.); Ebecryl 220 (aromatic urethane hexaacrylate from UCB). And a variety of urethane (meth)acrylate monomers and urea (meth)acrylate monomers are otherwise well-known in the art. Of course, in other embodiments, no urethane poly(meth)acrylate monomer or urea poly(meth)acrylate monomer is present.

In various embodiments, the one or more (meth)acrylate monomers include one or more monofunctional (meth)acrylate monomers selected from alkyl (meth)acrylates (e.g., 2-ethylhexyl (meth)acrylate and lauryl (meth)acrylate); ethoxylated alkylphenol (meth)acrylate; phenoxyethyl (meth)acrylate; 2-(2-ethoxyethoxy) ethyl (meth)acrylate; and poly(ethylene glycol) mono(meth)acrylate. While monofunctional (meth)acrylate monomers would not contribute strongly to network formation, the identity of their side group can impact final material properties, and so can be used by the person of ordinary skill in the art to arrive at a desired material.

As used herein, the term (meth)acrylate relates to both acrylates and methacrylates. The present inventors note that acrylates tend to react in Michael additions more quickly than do methacrylates. The person of ordinary skill in the art, based on the present disclosure, can use the relative amounts of acrylates and methacrylates (including one in the absence of the other) to help tune a desired reaction rate. In some uses, it may be desirable to crosslink more quickly, and in others it may be desirable to crosslink less quickly. This can depend on a number of factors, including the speed of foam formation (which in turn can depend on the identity of the blowing agent as well as temperature) and the desire to provide a material that remains somewhat workable for a time after initial dispensing and foaming. In various embodiments as otherwise described herein, one or more of the one or more (meth)acrylate monomers is an acrylate monomer. For example, in some desirable embodiments, each of the one or more (meth)acrylate monomers is an acrylate monomer. However, in other embodiments, some or all of the one or more (meth)acrylate monomers may be methacrylate monomers.

As the person of ordinary skill in the art will appreciate, the properties of the final expanded and cured foam material will depend strongly on the structure(s) of the one or more (meth)acrylate monomers. For example, the glass transition temperature and mechanical properties such as rigidity and strength of the expanded foam material can be tuned by selecting (meth)acrylate monomers having particular crosslinking densities and particular structures otherwise (e.g., hard or soft domains to provide for more or less rigidity). Moreover, particular functionalities or polarities can be provided to lend a variety of properties to the material, e.g., to provide desired surface energy or adhesive properties, or to provide functionalities for other reactions. Fire performance can also be tuned, e.g., by providing halogenated monomers. Relative amounts of mono- and polyfunctional (meth)acrylate monomers can also help tune properties, e.g., by tuning crosslink density.

The one or more (meth)acrylate monomers can be present in the expandable foam formulation in a variety of amounts. For example, in various embodiments as otherwise described herein, the one or more (meth)acrylate monomers are present in a total amount in the range of 10-80 wt %, e.g., in the range of 10-70 wt %, or 10-60 wt %, or 10-50 wt %, or 20-80 wt %, or 20-70 wt %, or 20-60 wt %, or 20-50 wt %. Suitable amounts will vary depending on the identities of the one or more (meth)acrylate monomers, the identities of other components, and the desired material properties.

A wide variety of epoxy monomers can be used in the materials of the disclosure. The person of ordinary skill in the art will select desirable epoxy monomers, for example of desirable chain lengths and flexibilities, to provide desirable properties, e.g., desirable mechanical properties, to the final crosslinked polymer.

For example, in various desirable embodiments as otherwise described herein, the one or more epoxy monomers include one or more polyfunctional epoxy monomers. When one or more polyfunctional epoxy monomers are provided, they can act to crosslink the final cured material. The person of ordinary skill in the art will appreciate that the degree of functionality of the polyfunctional epoxy monomer will impact the crosslink density of the polymer. In various embodiments, the one or more epoxy monomers comprise at least one trifunctional epoxy monomer. In various embodiments, the one or more epoxy monomers comprise a difunctional epoxy monomer, a tetrafunctional epoxy monomer, and/or a pentafunctional epoxy monomer. However, in some embodiments, a monofunctional epoxy can be included to modify polymer properties without itself providing substantial crosslinking. The monofunctional epoxy monomer can be provided together with polyfunctional epoxy monomer, or, in cases where a polyfunctional amine and a polyfunctional (meth)acrylate are provided, in the absence of a polyfunctional epoxy.

The person of ordinary skill in the art will appreciate that the molecular weight of a polyfunctional epoxy monomer will also impact the crosslink density of a polymer. And the chain length of a monofunctional epoxy monomer will affect overall material properties. The person of ordinary skill in the art can, based on the present disclosure, select a desired molecular weight of the epoxy component(s). For example, in various embodiments as described herein, at least one of (e.g., each of) the one or more epoxy monomers has a weight-average molecular weight in the range of 174 g/mol to 2000 g/mol, e.g., in the range of 174-1500 g/mol, or 174-1000 g/mol, or 174-700 g/mol, or 250-2000 g/mol, or 250-1500 g/mol, or 250-1000 g/mol, or 250-700 g/mol. Such molecular weights, when provided in polyfunctional epoxy monomers, can provide for relatively high crosslink densities and associated material properties. However, in some embodiments, higher-molecular weight materials can be provided; for example, in various embodiments as otherwise described herein, at least one of (e.g., each of) the one or more epoxy monomers has a weight-average molecular weight in the range of 2,000 g/mol to 200,000 g/mol, e.g., in the range of 2,000-100,000 g/mol, or 2,000-50,000 g/mol, or 2,000-20,000 g/mol, or 10,000-200,000 g/mol, or 10,000-100,000 g/mol, or 10,000-50,000 g/mol, or 20,000-200,000 g/mol.

In various embodiments, the one or more epoxy monomers includes one or more of bisphenol diglycidyl ethers such as bisphenol A diglycidyl ether; ethylene glycol diglycidyl ether; 1,ω alkanediol diglycidyl ethers;

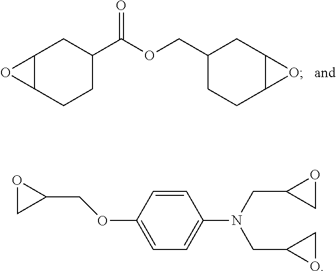 [SMILES: O=C(OCC1CCC2OC2C1)C1CCC2OC2C1 ; "and" ; c1cc(N(CC2CO2)CC2CO2)ccc1OCC1CO1]

Other suitable epoxy monomers include epoxy-functional polyether monomers (e.g., di(ethylene glycol) diglycidyl ether, tri(ethylene glycol) diglycidyl ether, poly(ethylene glycol) diglycidyl ether and poly(propylene glycol) diglycidyl ether); epoxy-functional polyester monomers (e.g., in which the polyester is obtained by reacting a polyhydric alcohol (e.g. ethylene glycol, a polyethylene glycol, propylene glycol, a polypropylene glycol, tetramethylene glycol, a polytetramethylene glycol, 1,6-hexanediol, neopentyl glycol, 1,4-cyclohexane dimethanol, 3-methyl-1,5-pentanediol, 1,9-nonanediol, and 2-methyl-1,8-octanediol) with a polybasic acid (e.g., phthalic acid, isophthalic acid, terephthalic acid, maleic acid, fumaric acid, adipic acid, and sebacic acid)) and epoxy-functional silicone monomers (e.g., epoxypropoxypropyl)dimethoxysilyl-terminated polydimethylsiloxane).

In some embodiments, the one or more epoxy monomers include one or more epoxy-functional urethane monomers and/or one or more epoxy-functional urea monomers. While urethanes and ureas are synthesized using isocyanates, the materials themselves can be provided with sufficiently low amounts of residual isocyanate so as not to pose a significant health and safety risk. Of course, in other embodiments, no epoxy-functional urethane or epoxy-functional urea is present.

In various embodiments, the one or more epoxide monomers include one or more monofunctional epoxide monomers selected from alkyl epoxides (e.g., 1,2-epoxyheptane), tert-butyl glycidyl ether, 1,2-epoxycyclohexane, glycidyl 2-methoxyphenyl ether, 2,4-dibromoglycidyl ether, and polyethylene glycol glycidyl lauryl ether). While monofunctional epoxide monomers would not themselves contribute strongly to network formation, the identity of their side group can impact final material properties, and so can be used by the person of ordinary skill in the art to arrive at a desired material.

The one or more epoxy monomers can be present in the expandable foam formulation in a variety of amounts. For example, in various embodiments as otherwise described herein, the one or more epoxy monomers are present in a total amount in the range of 10-80 wt %, e.g., in the range of 10-70 wt %, or 10-60 wt %, or 10-50 wt %, or 20-80 wt %, or 20-70 wt %, or 20-60 wt %, or 20-50 wt %. Suitable amounts will vary depending on the identities of the one or more epoxy monomers, the identities of other components, and the desired material properties.

As the person of ordinary skill in the art will appreciate, the properties of the final expanded and cured foam material will depend strongly on the structure(s) of the one or more epoxy monomers. For example, the glass transition temperature and mechanical properties such as rigidity and strength of the expanded foam material can be tuned by selecting epoxy monomers having particular crosslinking densities and particular structures otherwise (e.g., hard or soft domains to provide for more or less rigidity). Moreover, particular functionalities or polarities can be provided to lend a variety of properties to the material, e.g., to provide desired surface energy or adhesive properties, or to provide functionalities for other reactions. Fire performance can also be tuned, e.g., by providing halogenated monomers. Relative amounts of mono- and polyfunctional epoxy monomers can also help tune properties, e.g., by tuning crosslink density.

(Meth)acrylate monomers and epoxy monomers are often commercially available as mixtures. For example, EPON 8111 is a mixture of trimethylolpropane triacrylate and bisphenol A epoxy resin). Others include EPON 8161, EPON 8101 and EPON 8021 (mixture of bisphenol A epoxy and 1,6-hexanediol diacrylate).

In various embodiments, the expandable foam formulation includes both of a one or more (meth)acrylate monomers and one or more epoxy monomers. In various such embodiments, no epoxy (meth)acrylate monomer is present.

In other embodiments, one or more epoxy (meth)acrylate monomers are present in the formulation. An epoxy (meth)acrylate monomer has both epoxy functionality and (meth)acrylate functionality. Notably, epoxy (meth)acrylate monomers can provide both the epoxy and (meth)acrylate functionalities necessary for polymer formation. Accordingly, one or more epoxy (meth)acrylate monomers can be present together with one or (meth)acrylate monomers and/or one or more epoxy monomers, or can be present without (meth)acrylate monomers and epoxy monomers.

A wide variety of epoxy (meth)acrylate monomers are suitable. For example, in various embodiments, the one or more epoxy (meth)acrylate monomers comprise one or more of glycidyl (meth)acrylate and 1-(2-(glycidyloxy) ethoxy) ethyl methacrylate. Of course, other monomers are possible, e.g., oligomers bearing both epoxy and (meth)acrylate functionalities.

The one or more epoxy (meth)acrylate monomers can be present in the expandable foam formulation in a variety of amounts. For example, in various embodiments as otherwise described herein, the one or more epoxy (meth)acrylate monomers are present in a total amount in the range of 10-80 wt %, e.g., in the range of 10-70 wt %, or 10-60 wt %, or 10-50 wt %, or 20-80 wt %, or 20-70 wt %, or 20-60 wt %, or 20-50 wt %. Suitable amounts will vary depending on the identities of the one or more epoxy (meth)acrylate monomers, the identities of other components, and the desired material properties.

As the person of ordinary skill in the art will appreciate, the properties of the final expanded and cured foam material will depend strongly on the structure(s) of the one or more epoxy (meth)acrylate monomers. For example, the glass transition temperature and mechanical properties such as rigidity and strength of the expanded foam material can be tuned by selecting epoxy (meth)acrylate monomers having particular crosslinking densities and particular structures otherwise (e.g., hard or soft domains to provide for more or less rigidity). Moreover, particular functionalities or polarities can be provided to lend a variety of properties to the material, e.g., to provide desired surface energy or adhesive properties, or to provide functionalities for other reactions.

A wide variety of primary amine monomers can be used in the materials of the disclosure. The person of ordinary skill in the art will select desirable primary amine monomers, for example of desirable chain lengths and flexibilities, to provide desirable properties, e.g., desirable mechanical properties, to the final crosslinked polymer.

For example, in various desirable embodiments as otherwise described herein, the one or more primary amine monomers include one or more polyfunctional primary amine monomers. When one or more polyfunctional primary amine monomers are provided, they can act to crosslink the final cured material. The person of ordinary skill in the art will appreciate that the degree of functionality of the polyfunctional primary amine monomer will impact the crosslink density of the polymer. For example, in some embodiments, the one or more the one or more primary amine monomers include one or more primary amine monomers having a number-average functionality of at least 10 primary amines/mol, e.g., at least 20 primary amines/mol. In various embodiments, the one or more primary amine monomers include one or more primary amine monomers having a functionality of 2-10 primary amines/mol, e.g., 2-5 primary amines/mol. However, in some embodiments, a monofunctional primary amine monomer can be included to modify polymer properties without itself providing substantial crosslinking. These can be provided together with polyfunctional primary amine monomer, or, in cases where a polyfunctional epoxy monomer and a polyfunctional (meth)acrylate monomer are provided, in the absence of a polyfunctional primary amine monomer.

The person of ordinary skill in the art will appreciate that the molecular weight of a polyfunctional primary amine monomer will also impact the crosslink density of a polymer. And the chain length of a monofunctional primary amine monomer will affect overall material properties. The person of ordinary skill in the art can, based on the present disclosure, select a desired molecular weight of the primary amine component(s). For example, in various embodiments as described herein, at least one of (e.g., each of) the one or more primary amine monomers has a weight-average molecular weight in the range of 103 g/mol to 50000 g/mol, e.g., in the range of 103-25000 g/mol, or 103-10000 g/mol, or 103-2500 g/mol, or 103-1000 g/mol, or 500-50000 g/mol, or 500-25000 g/mol, or 500-10000 g/mol, or 500-2500 g/mol, or 1000-50000 g/mol, or 1000-25000 g/mol, or 1000-10000 g/mol, or 1000-2500 g/mol.

In various embodiments, the one or more primary amine monomers includes one or more include a primary amine-bearing polymer, e.g., a polyethyleneimine. In some embodiments, the polyethyleneimine has a primary amine content in the range of 15-50 mol % (i.e., as percentage of total amine). Examples of suitable polyethyleneimines include Lupasol FG (BASF) and polyethyleneimines from Polyscience (e.g., branched polyethyleneimines). In various embodiments, the primary amine-bearing polymer (e.g., the polyethyleneimine) has a weight-average molecular weight in the range of 500 g/mol to 10000 g/mol, e.g., in the range of 500-8000 g/mol, or 500-6000 g/mol, or 1000-10000 g/mol, or 1000-8000 g/mol, or 1000-6000 g/mol.

In various embodiments, the one or more primary amine monomers includes one or more non-polymeric amine monomers. A wide variety are suitable, depending on the desired material properties. For example, in various embodiments, the one or more amine monomers includes diethylenetriamine, which can be provided, e.g., in combination with 4,4′-ispropylidenephenol) in EPIKURE 3271. In various embodiments, the one or more monomers include one or more of 4,4-bis(aminomethyl) toluene, 2,5-bis(aminomethyl)-p-xylene, bis(aminomethyl) durene, 2,4-bis(aminoethyl)-1,3,5-triisopropylbenzene, triethylene tetraamine, tetraethylene pentaamine, isophorone diamine, bis-paraaminocyclohexyl methane, 1,2-diaminocyclohexane (1,2-DACH), alkylamines such as 1,6-hexanediamine, 1,8-octanediamine, and 1,10-decanediamine, as well as etheramines such as 1,2-bis-(aminopropoxy)-ethane, 1,3-bis-(3-aminopropoxy) propane and 2,2-dimethyl-1,3-bis(3-aminopropoxy) propane. A wide variety of amidoamines can also be used, e.g., those available under the ChemCure®, EPIKURE™, and Jointmide brands.

As above, monofunctional primary amine monomers can be used to tune properties, without substantially crosslinking. A variety of aliphatic and aromatic amines can be used.

The one or more primary amine monomers can be present in the expandable foam formulation in a variety of amounts. For example, in various embodiments as otherwise described herein, the one or more primary amine monomers are present in a total amount in the range of 5-50 wt %, e.g., in the range of 5-40 wt %, or 5-30 wt %, or 5-20 wt %, or 10-50 wt %, or 10-40 wt %, or 10-30 wt %. Suitable amounts will vary depending on the identities of the one or more primary amine monomers, the identities of other components, and the desired material properties.

Here, too, the properties of the final expanded and cured foam material will depend strongly on the structure(s) of the one or more primary amine monomers. For example, the glass transition temperature and mechanical properties such as rigidity and strength of the expanded foam material can be tuned by selecting primary amine monomers having particular crosslinking densities and particular structures otherwise (e.g., hard or soft domains to provide for more or less rigidity). Moreover, particular functionalities or polarities can be provided to lend a variety of properties to the material, e.g., to provide desired surface energy or adhesive properties, or to provide functionalities for other reactions. Fire performance can also be tuned, e.g., by providing halogenated monomers. Relative amounts of mono- and polyfunctional primary amine monomers can also help tune properties, e.g., by tuning crosslink density. The nucleophilicity and thus the rate of the Michael addition can also be tuned with selection of amine.

The person of ordinary skill in the art will provide relative amounts of the one or more (meth)acrylate monomers, one or more epoxide monomers, and one or more primary amine monomers to provide molar ratios of functionalities that will provide for a desired degree of reaction.

For example, in various embodiments, the molar ratio of reactive amine moieties of the one or more primary amine monomers to (meth)acrylate moieties of the one or more (meth)acrylate monomers and the one or more epoxy (meth)acrylate monomers in the expandable foam formulation is at least 1:2, e.g., at least 1:1.5. In various embodiments, the molar ratio of primary amine moieties of the one or more primary amine monomers to (meth)acrylate moieties and the one or more epoxy (meth)acrylate monomers of the one or more (meth)acrylate monomers in the expandable foam formulation is at least 1:1.1, or at least 1:1.05, or at least 1:1. For example, in various embodiments, the molar ratio of primary amine moieties to (meth)acrylate and the one or more epoxy (meth)acrylate monomers moieties in the expandable foam formulation is in the range of 4:1 to 1:2, e.g., in the range of 4:1 to 1:1.5, or 4:1 to 1:1.1, or 4:1 to 1:1.05, or 4:1 to 1:1, or 3:1 to 1:2, or 3:1 to 1:1.5, or 3:1 to 1:1.1, or 3:1 to 1:1.05, or 3:1 to 1:1. In various embodiments, the molar ratio of primary amine moieties to (meth)acrylate moieties and the one or more epoxy (meth)acrylate monomers in the expandable foam formulation is in the range of 2:1 to 1:2, e.g., 2:1 to 1:1.5, or 2:1 to 1:1.1, or 2:1 to 1:1.05, or 2:1 to 1:1, or 1.5:1 to 1:2, or 1.5:1 to 1:1.5, or 1.5:1 to 1:1.1, or 1.5:1 to 1:1.05, or 1.5:1 to 1:1.

In various embodiments, the molar ratio of primary amine moieties to epoxy moieties (i.e., of the one or more epoxy monomers and the one or more epoxy (meth)acrylate monomers) in the expandable foam formulation is in the range of 4:1 to 1:4, e.g., in the range of 4:1 to 1:3, or 4:1 to 1:2, or 4:1 to 1:1.2, or 4:1 to 1:1, or 3:1 to 1:4, or 3:1 to 1:3, or 3:1 to 1:2, or 3:1 to 1:2, or 3:1 to 1:1, or 2:1 to 1:4, or 2:1 to 1:3, or 2:1 to 1:2, or 2:1 to 1:1.2, or 2:1 to 1:1, or 1.2:1 to 1:4, or 1.2:1 to 1:3, or 1.2:1 to 1:2, or 1.2:1 to 1:1.2, or 1.2:1 to 1:1.

In many cases, it is desirable that there is sufficient (meth)acrylate and epoxy present to react away a substantial fraction of the primary amine. For example, in some embodiments, the molar ratio of primary amine moieties to epoxy moieties in the expandable foam formulation is no more than 1.5:1, e.g., no more than 1.1:1, or no more than 1.05:1, or no more than 1:1. In various embodiments, the molar ratio of primary amine moieties to the sum of the molar ratio of epoxy moieties and the molar ratio of (meth)acrylate moieties is in the range of 1.5:1 to 1:4, e.g., 1.5:1 to 1:3, or 1.5:1 to 1:2, or 1.5:1 to 1:1.5, or 1.1:1 to 1:4, or 1.1:1 to 1:3, or 1.1:1 to 1:2, or 1.1:1 to 1:1.5, or 1.05:1 to 1:4, or 1.05:1 to 1:3, or 1.05:1 to 1:2, or 1.05:1 to 1:1.5, or 1:1 to 1:4, or 1:1 to 1:3, or 1:1 to 1:2, or 1:1 to 1:1.5.

In various aspects of the disclosure, the expandable foam formulation includes a blowing agent. As the person of ordinary skill in the art will appreciate, a blowing agent provides gas that can form the bubbles of the foam; the material cures with these bubbles in place, thus providing a foamed product. Blowing agents are often materials with low boiling points, which can evaporate to gas when dispensed from a pressurized container and/or with the heat generated by crosslinking, or are substances that will chemically react to provide a gas under the dispensing conditions. In various embodiments as otherwise described herein, the blowing agent is itself a volatile compound that evaporates when dispensed. For example, in various embodiments as otherwise described herein, the one or more blowing agents include one or more hydrofluoroolefin blowing agents. For example, in some embodiments the one or more blowing agents include one or more of cis-1,1,1,4,4,4-hexafluoro-2-butene (OPTEON 1100) and trans-1,1,1,4,4,4-hexafluoro-2-butene (OPTEON 1150). In some embodiments, the one or more blowing agents include 1,3,3,3-Tetrafluoropropene (HFO-1234ze) (e.g., Solstice HFO) In various embodiments as otherwise described herein, the one or more blowing agents include one or more volatile hydrocarbons (e.g., butane, pentane). The one or more blowing agents can be provided as other gases like nitrogen and carbon dioxide.

The person of ordinary skill in the art will use an amount of blowing agent suitable to provide desired foam characteristics. For example, in various embodiments as otherwise described herein, the one or more blowing agents are present in an amount in the range of 5 wt % to 30 wt %, e.g., 5-25 wt %, or 5-20 wt %, or 5-15 wt %, or 10-30 wt %, or 10-25 wt %, or 10-20 wt %, or 15-30 wt %, or 15-25 wt %.

However, as described in more detail below, formulations as described herein but without a blowing agent can be used to provide a foam material, e.g., using physical manipulation to beat air or some other gas into the formulation to make bubbles, or using a separate stream of gas (e.g., nitrogen, air) to froth the foam before or during curing (e.g., at the time of dispensing).

Other reactive compounds can be included in the expandable foam formulation. For example, in various embodiments as otherwise described herein, the expandable foam formulation further includes one or more phenols. The present inventors have determined that phenols can be used to modify material properties and to modify the reaction rate. Without intending to be bound by theory, the present inventors believe the presence of a phenol can modify reaction rate in two ways. First, a phenol can increase the rate of overall reaction by activating addition to epoxy monomers. A phenol can also participate in acid/base reaction with primary amines, protonating them to ammoniums and making them less reactive in the Michael addition. Depending on the balance of these processes, use of a phenol can speed overall reaction or slow overall reaction.

In various embodiments as otherwise described herein, the one or more phenols include one or more polyfunctional phenols. For example, in some embodiments, the one or more phenols include one or more difunctional phenols. In some embodiments, the one or more phenols include one or more trifunctional phenols and/or one or more tetrafunctional phenols.

The person of ordinary skill in the art will appreciate that the molecular weight of a polyfunctional phenol can also impact the crosslink density of a polymer. And the molecular weight of a monofunctional phenol will affect overall material properties. The person of ordinary skill in the art can, based on the present disclosure, select a desired molecular weight of the phenol component(s). For example, in various embodiments as described herein, at least one of (e.g., each of) the one or more phenols has a weight-average molecular weight in the range of range of 228 g/mol to 2000 g/mol, e.g., in the range of 228-1500 g/mol, or 228-1000 g/mol, or 228-700 g/mol. Such molecular weights, when provided in polyfunctional phenols, can provide for relatively high crosslink densities and associated material properties. However, in some embodiments, higher-molecular weight materials can be provided; for example, in various embodiments as otherwise described herein, at least one of (e.g., each of) the one or more phenols has a weight-average molecular weight in the range of 2,000 g/mol to 200,000 g/mol, e.g., in the range of 2,000-100,000 g/mol, or 2,000-50,000 g/mol, or 2,000-20,000 g/mol, or 10,000-200,000 g/mol, or 10,000-100,000 g/mol, or 10,000-50,000 g/mol, or 20,000-200,000 g/mol.

In various embodiments, the one or more phenols include one or more Bisphenols. For example, in various embodiments, the one or more phenols include one or more of Bisphenol A and Bisphenol Z (23,24,25,26-tetrahydro-22H-[11,21:21,31-terphenyl]-14,34-diol). In various embodiments, the one or more phenols include one or more of Bisphenol AP, Bisphenol AF, Bisphenol B, Bisphenol BP, Bisphenol C, Bisphenol C2, Bisphenol E, Bisphenol F, Bisphenol G, Bisphenol M, Bisphenol S, Bisphenol P, Bisphenol PH, Bisphenol TMC, dinitrobisphenol A and tetrabromobisphenol A.

Notably, halogenated phenols like tetrabromobisphenol A and tribromophenol can provide flame retardant activity. Accordingly, in various embodiments, the one or more phenols include one or more halogenated phenols, e.g., one or more halogenated polyfunctional phenols. The halogenation can in some embodiments be one or more of chlorination and bromination.

The one or more phenols, when present, can be present in the expandable foam formulation in a variety of amounts. For example, in various embodiments as otherwise described herein, the one or more phenols are present in a total amount up to 20 wt %, e.g., up to 15 wt %, or up to 10 wt %, or in the range of 1-20 wt %, or 1-15 wt %, or 1-10 wt %, or 2-20 wt %, or 2-15 wt %, or 2-10 wt %, or 5-20 wt %, or 5-15 wt %, or 5-10 wt %. Suitable amounts will vary depending on the identities of the one or more phenols, the identities of other components, and the desired material properties.

Non-phenolic alcohols can also advantageously be used to modify material properties. A wide variety of nonphenolic alcohols can be used, including aliphatic alcohols and non-phenolic aromatic alcohols, and including monofunctional and polyfunctional alcohols. The person of ordinary skill in the art will select particular alcohols to be used based on desired material properties. Accordingly, in various embodiments, the expandable foam formulation as otherwise described herein includes one or more non-phenolic alcohols, e.g., as monofunctional alcohols and/or polyfunctional alcohols.

Notably, the person of ordinary skill in the art will be aware of a variety of non-phenolic alcohols that themselves are reactive flame retardants, i.e., a compound with alcohol functionality that provides flame retardance. Such compounds are often halogenated (e.g., Cl and/or Br) or include phosphorus (e.g., as phosphates or phosphonates). Accordingly, in various embodiments the one or more non-phenolic alcohols include one or more flame-retardant alcohols, e.g., as polyfunctional alcohols and/or as monofunctional alcohols. In various embodiments, the one or more flame-retardant alcohols include one or more phosphorus containing alcohols, e.g., one or more phosphorus-containing polyfunctional alcohols or one or more phosphorus-containing monofunctional alcohols. The phosphorus can be, e.g., in the form of phosphate or phosphonate. Examples of such compounds include diethyl N,N-bis(2-hydroxyethyl) aminomethylphosphonate (Fyrol 6, also Lanxess 4090N); diethyl (hydroxymethyl)phosphonate;

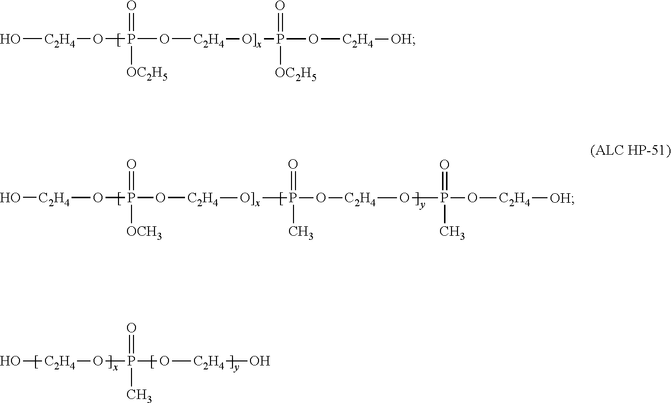

(EXOLIT OP 560); EXOLIT OP 550 (Phosphate ester with hydroxyalkyl groups having the following properties: phosphorus content: 17.0%; hydroxyl value: 130 KOHmg/g; acid value: 1.3 KOH mg/g; viscosity (25° C.): 2.1 Pa·s; weight average molecular weight: 863 g/mol); and SAFRON 6600 series materials (alcohol-functional phosphonate). In various embodiments, the one or more flame-retardant alcohols include one or more halogenated alcohols, e.g., one or more halogenated polyfunctional alcohols or one or more halogenated monofunctional alcohols. The halogenation can be, e.g., chlorination and/or bromination. Examples of such compounds include tetrabromophthalic anhydride diol (2-(2-hydroxyethoxy) ethyl 2-hydroxypropyl 3,4,5,6-tetrabromophthalate), tribromoneopentyl alcohol and dibromoneopentyl glycol.

The one or more non-phenolic alcohols (e.g., non-phenolic flame retardant alcohols) when present, can be present in the expandable foam formulation in a variety of amounts. For example, in various embodiments as otherwise described herein, the one or more non-phenolic alcohols are present in a total amount up to 20 wt %, e.g., up to 15 wt %, or up to 10 wt %, or in the range of 1-20 wt %, or 1-15 wt %, or 1-10 wt %, or 2-20 wt %, or 2-15 wt %, or 2-10 wt %, or 5-20 wt %, or 5-15 wt %, or 5-10 wt %. Suitable amounts will vary depending on the identities of the one or more non-phenolic alcohols, the identities of other components, and the desired material properties.

When alcohols like phenols and non-phenolic alcohols are present, it can be desirable in some embodiments to keep their proportion relatively low. For example, in various embodiments as otherwise described herein, the molar ratio of phenolic and non-phenolic alcohol-OH groups to epoxide groups of the one or more epoxy monomers is no more than 0.2:1, e.g., no more than 0.15:1 or no more than 0.1:1.

The present inventors have noted that many suitable materials, including various materials for use in insulating building cavities, can be formed chiefly from (meth)acrylate monomer(s), epoxy monomer(s), epoxy (meth)acrylate monomers, primary amine monomer(s), optional blowing agent, and, optionally, phenols and/or non-phenolic alcohols, as described above. Accordingly, in various embodiments as otherwise described herein, the total amount of (meth)acrylate monomer(s), epoxy monomer(s), epoxy (meth)acrylate monomer(s), primary amine monomer(s), and, if present, blowing agent, phenols and/or non-phenolic alcohols in the expandable foam formulation material is at least 50 wt %, e.g., at least 60 wt %, at least 70 wt %, or at least 80 wt %.

Of course, depending on the desired properties of the uncured and cured materials, the expandable foam formulation can include a variety of other components. The person of ordinary skill in the art will select appropriate identities and amounts of other such components, based on disclosure herein and with reference to, e.g., the identities of the (meth)acrylate monomer(s), epoxy monomer(s), epoxy (meth)acrylate monomer(s), primary amine monomer(s), optional blowing agent, and, optionally, phenols and/or non-phenolic alcohols present in the expandable foam formulation and the desired properties of the uncured and cured materials.

For example, in various embodiments as otherwise described herein, the expandable foam formulation further includes a surfactant, for example, in an amount up to 5 wt %. A surfactant can, for example, aid in foam formation and retention and/or improve wetting of a material against which the expandable foam formulation is dispensed. A variety of silicone surfactants can be suitable for use, as can any of a variety of other types of surfactants.

The text above describes the use of certain reactive phenolic or non-phenolic alcohol fire retardants. The person of ordinary skill in the art will appreciate that other fire retardants can, in some embodiments, be alternatively or additionally present. For example, in various embodiments as otherwise described herein, the expandable foam formulation further includes one or more non-alcoholic flame retardants. For example, in various embodiments, the expandable foam formulation includes one or more particulate fire retardants. These can be one or more of, e.g., melamine polyphosphate, ammonium polyphosphate, and expandable graphite. Other non-alcoholic fire retardants include organophosphorus compounds such as triethyl phosphate, tris(1,3-dichloroisopropyl) phosphate, resorcinol bis(diphenyl phosphate), (1-chloro-2-propyl) phosphate, 2,2-bis(chloromethyl) propane-1,3-diyl tetrakis(1-chloropropan-2-yl) bis(phosphate), tris (2-chloroethyl) phosphate and 9-10-dihydro-9-oxa-10-phosphaphenanthrene-10-oxide (DOPO); and chlorinated paraffins. In various embodiments, the one or more non-alcoholic fire retardants are present in an amount up to 40 wt %, e.g., up to 30 wt %, or up to 20 wt %. For example, in various embodiments, the one or more particulate fire retardants are present in an in the range of 1-40 wt %, or 1-30 wt %, or 1-20 wt %, or 5-40 wt %, or 5-30 wt %, or 5-20 wt %, or 10-40 wt %, or 10-30 wt %, or 20-40 wt %.

Water-containing minerals can also be used to improve the fire resistance of a material as described herein. For example, in certain embodiments, an expandable foam formulation as otherwise described herein includes one or more water-containing minerals having a dehydratable water content of at least 15 wt %. The dehydratable water is water that will be dehydrated from the mineral at or below a temperature of 400° C. This can be, for example, water bound as water of crystallization (e.g., as in gypsum), or water nominally present as hydroxide (e.g., as in aluminum trihydroxide). And in certain embodiments, an expandable foam insulation material as otherwise described herein includes one or more water-containing minerals having a dehydratable water content, the one or more minerals being selected from aluminum trihydrate (e.g., gibbsite), magnesium dihydrate, gypsum and magnesium carbonate hydrate. The water-containing minerals can in some embodiments be provided with coatings to enhance compatibility with the polymeric material of the foam (e.g., a hydrophobic coating). The water-containing minerals can be present in any suitable amount, such as wherein the one or more water-containing minerals are present in the expandable foam formulation in an amount in the range of 5-60 wt %, e.g., 5-45 wt % or 15-60 wt % or 15-45 wt % or 30-60 wt %.

The present inventors have noted that by foregoing the use of urethane chemistry to cure the polymer material, the use of isocyanates can be avoided. Accordingly, in various embodiments as otherwise described herein, the expandable foam formulation includes no more than 500 ppm isocyanate (i.e., quantified on a weight basis as —NCO), e.g., no more than 100 ppm, or no more than 50 ppm.

One desirable application for the foam materials described herein is an injectable form for insulation of wall cavities. For example, the materials described herein can be provided as a foam insulation product for building retrofits, suitable for injection as a frothed foam liquid behind interior walls of a building. Upon injection the foamed liquid rises to substantially fill the empty cavity while curing into a solid insulative foam. Curing foams exert an outward force on the walls of a cavity in which they are cured. After the reacting foam has gelled and stopped rising, the still-proceeding exothermic polymerization reaction causes the internal gases to push out against the soft, partially-cured foam until the reaction stops and the foam cools down. This rise pressure can be great enough to cause permanent bowing of the gypsum wall or even push the wall through the screw anchors causing localize sink marks.

The present inventors surmise that reaction rate is a key driver for pressure control, as slowing reaction rate can spread the polymerization exotherm over longer times and keeps the overall reaction temperature, and in turn the overall gas pressure, from reaching undesirably high levels. The present inventors have noted that inclusion of phenol monomers, use of methacrylate monomers, or use of less active amines like amidoamines can slow the reaction rate, providing a convenient way to tune reaction rate. Of course, selection of other components can also be used to provide a desirable reaction rate.

In various embodiments as otherwise described herein, pressure buildup before the time of peak rise is acceptable, because the foam is able to continue expanding. But when the foam reaches its peak rise, believed to be in the neighborhood of (e.g., shortly after) the gel point of the material, this mechanism for pressure relief no longer exists, and so pressure build after this point exerts itself most strongly on the wall(s) of a cavity into which the foam is dispensed. Accordingly, design and use of materials with such characteristics together with other desirable characteristics for use as building insulation materials (e.g., in some embodiments, flame resistance) can provide for improved installation and use of expandable foam formulations.

In various embodiments, the disclosure provides an expandable foam formulation, the expandable foam formulation being expandable to provide an expanded foam material, the expandable foam formulation having a maximum foam height; and a final peak pressure of no more than 1000 Pa, wherein for each local pressure maximum in excess of 50 Pa, a time difference between a time of the local pressure maximum and a time of 95% maximum foam height is no more than 100 seconds.

Pressure, foam height, shrinkage, foam temperature and timing thereof are measured using a FOAMAT® Foam Qualification System. 100 grams of expandable foam formulation is dispensed (dispense pressure ˜100 psi) into a 6″ cardboard cylinder and placed under the ultrasonic sensor of the Foam Qualification System, and data are collected from the ultrasonic sensor (foam rise height), the pressure sensor at the bottom of the cylinder (pressure), and thermocouple (temperature, metal-sheathed, ⅛″ OD thermocouple) inserted into the foam core. The foaming reaction is then monitored for at least 300 seconds.

The maximum foam height is determined as the maximum height of the foam achieved during the 300 seconds of measurement in the FOAMAT® Foam Qualification System.

In certain aspects, the expandable foam formulation has no local pressure maximum of more than 1000 Pa. As used herein, the local pressure maximum is a local maximum in pressure that occurs during the 300 seconds of measurement in the FOAMAT® Foam Qualification System that is in excess of 50 Pa in pressure. Without intending to be bound by theory, the inventors believe that a relatively low pressure maximum can help to prevent blow-out. In certain embodiments as otherwise described herein, the expandable foam formulation has no local pressure maxima of more than 700 Pa, or even no local pressure maxima of more than 500 Pa. For example, in certain embodiments, the expandable foam formulation has a highest local pressure maximum in the range of 100-1000 Pa, e.g., 100-700 Pa, or 200-1000 Pa or 200-700 Pa. In certain embodiments, the expandable foam formulation has a highest local pressure maximum in the range of 50-300 Pa, e.g., 100-300 Pa, or 50-250 Pa, or 100-250 Pa.

But the present inventors have determined that low local pressure maxima in many cases are not sufficient to prevent blow-out. Rather, the present inventors have determined that blow-out risk is significantly reduced when for each local pressure maximum in excess of 50 Pa, a time difference between a time of the local pressure maximum and a time of 95% maximum foam height is no more than 100 seconds. The time of 95% maximum foam height is the earliest time during the 300 seconds of measurement in the FOAMAT® Foam Qualification System at which the foam height reaches 95% of its maximum value. In certain desirable embodiments, for each local pressure maximum in excess of 50 Pa, a time difference between a time of the local pressure maximum and a time of 95% maximum foam height is no more than 90 seconds, e.g., no more than 80 seconds. In certain desirable embodiments, for each local pressure maximum in excess of 50 Pa, a time difference between a time of the local pressure maximum and a time of 95% maximum foam height is no more no more than 70 seconds, e.g., no more than 60 seconds.

While the expansion of the foam will typically take some time to occur, in certain desirable embodiments the time of 95% maximum foam height is no more than 5 minutes, e.g., no more than 6 minutes. However, it can be desirable for the foam not to expand instantaneously; in certain embodiments, the time of 95% maximum foam height is at least 20 seconds, e.g., at least 40 seconds.

Desirable expandable foam formulation materials have a relatively low shrinkage from the maximum foam height. For example, in certain desirable embodiments, an expandable foam formulation as otherwise described herein has a shrinkage after five minutes (i.e., from the time of dispensing, measured as a percentage of maximum height in the FOAMAT® testing described herein) of no more than 10%, e.g., no more than 5%.

It can be desirable for the temperature in the expanding and curing foam not to get too high. In certain embodiments, the internal temperature of the foam is no more than 120° C., e.g., no more than 100° C. or no more than 80° C. Without intending to be bound by theory, it is believed that lower temperatures during expansion and curing can provide lower internal pressure, and thus provide a lower risk of blow-out.

Of course, while these curing parameters may be useful for certain applications, such as spray-in insulation materials, different curing speeds may be desirable. For example, in various embodiments, the expandable foam formulations of the disclosure can be provided as a fast-rising spray foam, e.g., with time of 95% maximum foam height of no more than 60 seconds, e.g., no more than 40 seconds or even no more than 20 seconds. Intermediate rise times, e.g., 1-2 minutes, and slower rise times, e.g., 2-10 minutes, may also be suitable in some applications.

Desirably, an expandable foam formulation of the disclosure has a tack-free time of no more than 5 minutes, e.g., no more than 4 minutes, or no more than 3 minutes.

The expandable foam formulation is typically in a partially-expanded state as it is dispensed, and it continues to expand to its final expanded and cured state after being dispensed. However, the person of ordinary skill in the art will appreciate that the expandable foam formulation can be dispensed in a variety of forms. The expandable foam formulation may not yet be substantially expanded, such that it is substantially expanded only after being dispensed. Or, precursors can mix in the dispenser to react and begin to expand, so that a partially-expanded foam formulation is what is dispensed into the cavity. Material described herein as “expandable foam formulation” encompasses any set of one or more precursors and/or reaction products thereof that are combined together to form the expanded foam formulation, and in turn the expanded foam material.

Another aspect of the disclosure is an expanded foam material that is the cured reaction product of an expandable foam insulation product as otherwise described herein, or the product of a method as described herein. The expanded foam material can have, e.g., an average burn rate of no more than 60 mm/min according to the UL 94 HBF test.

It is desirable in various embodiments that the foams provide thermal insulation. Typical thermal insulating values of insulation materials and insulation foams can be calculated by the ASTM C518 “Test Method for Steady-State Thermal Transmission Properties by Means for the Heat Flow Meter Apparatus.” In some embodiments, the foam made by the composition disclosed has a minimum R-value (F*h*sqft/Btu) of at least 2.0 per inch, e.g. at least 3.0 per inch, at least 3.5 per inch. In other embodiments, the foam may comprise a closed cell structure. In such cases, the thermal insulating values could be improved. In these cases, the closed cell foam made by the composition disclosed has a minimum R-value of at least 4.0 per inch, e.g. at least 5.0 per inch, at least 5.5 per inch. In various embodiments as otherwise described herein, foams made in either the open cell or closed cell configuration by these formulations would have an R-value per inch of less than 20.0, e.g. less than 15.0 R per inch, less than 12.0 R per inch.

Another aspect of the disclosure is a method for forming an expanded foam material, the method comprising causing the expandable foam formulation as described herein to expand and cure to form the expanded foam material. Methods and equipment useful in providing expanded polyurethane foam materials can likewise be used with the materials described herein.

When the expandable foam formulation itself includes a blowing agent, simply dispensing the expandable foam formulation can cause the expansion of the formulation, for example, when a blowing agent is itself a volatile material (e.g., volatile fluorocarbon or hydrocarbon). In other embodiments, reaction of the expandable foam formulation causes heating of the formulation, which in turn causes a chemical blowing agent to react to form gas (e.g., sodium bicarbonate forming carbon dioxide).

When the expandable foam formulation itself does not include a blowing agent, other steps can be taken to expand the formulation. For example, the expandable foam formulation can be agitated to create gas bubbles in the formulation, e.g., by beating or whipping air or another gas into the formulation. Agitation can be performed at any convenient time with respect to dispensing the formulation in place, e.g., before it is dispensed in place, during dispensing, or after dispensing. The expandable foam formulation can also be combined with a stream of gas, e.g., air or nitrogen, to form bubbles in the formulation. These processes will often happen simultaneously with reaction; indeed, in some embodiments, some degree of reaction is necessary for bubbles to remain stable in the formulation.

As noted above, one beneficial use of the materials described herein in the insulation of building cavities, e.g., wall cavities. Accordingly, another aspect of the disclosure is a method for providing a cavity of a building with an expanded foam material (e.g., as insulation), the cavity being enclosed by one or more walls including a first wall, the method comprising causing the expandable foam insulation formulation as described herein to expand and cure to form the expanded foam material in the cavity. In various embodiments of the methods as otherwise described herein, the cavity has a first wall having an aperture formed therein, and wherein the expandable foam formulation is dispensed into the cavity from the insulation dispenser through the aperture. The aperture can be pre-formed, or, in other embodiments, the method can include forming the aperture in the first wall before dispensing the insulation. The aperture can be patched after dispensing the foam insulation. The dispensing is performed in a plurality of discrete shots, so as to form multiple layers of expanded foam material in the cavity.

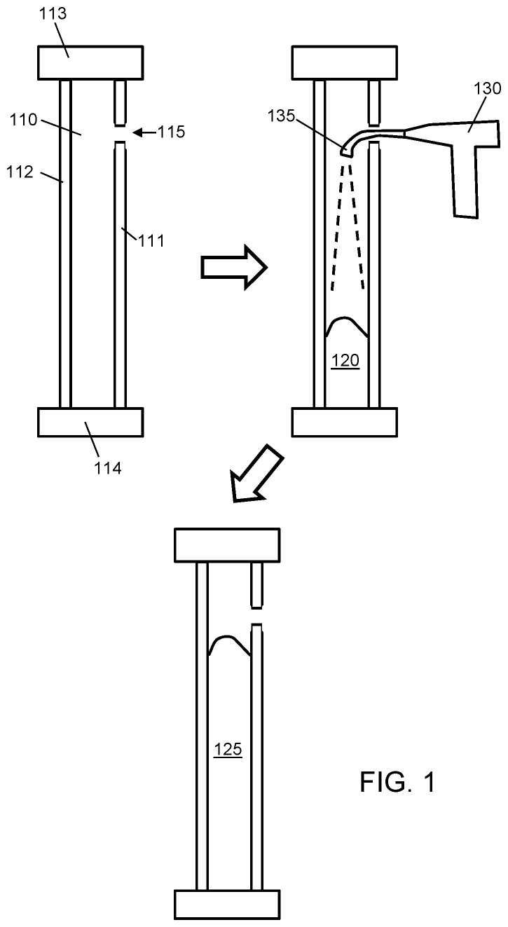

FIG. 1 is a schematic cross-sectional view of one embodiment of a method of dispensing of expandable foam formulation into a cavity at least partially enclosed by one or more walls. Wall cavity 110 includes a first wall 111, a second wall 112, a third wall 113 and a fourth wall 114, defining a substantially enclosed cavity. Wall cavity 110 can be closed off by two additional walls, e.g., parallel to the plane of the page. As is conventional, these walls can be formed of a variety of materials, e.g., wallboard, lath and plaster, cement, wood, metal, and different materials can be used in different walls of a particular cavity. One or more of the walls enclosing the cavity can be formed from framing members; in the example of FIG. 1, the first and second walls are wallboards and the third and fourth walls are framing members. And the person of ordinary skill in the art can appreciate that different cavities may have different shapes and thus different numbers of walls enclosing them. As used herein, a “substantially enclosed” cavity is enclosed over at least 90%, e.g., at least 95% of its surface area. The cavity can be, for example, a wall cavity, a ceiling cavity, or a floor cavity. The cavity thus need not be entirely enclosed. The person of ordinary skill in the art will appreciate that the methods described herein can be used in the insulation of a wide variety of building cavities. Such cavities can, in some cases, already have fibrous insulation (e.g., fiberglass) disposed therein. Expandable foam formulation 120 (e.g., in a mixed and partially-expanded state) is dispensed through an aperture 115 in the first wall 111 into the cavity 110 from an insulation dispenser 130 (often in the form of a “gun”), either directly from the tip of the dispenser or through a tube 135 extending into the cavity. After a volume of partially-expanded expandable foam formulation 120 is dispensed, it continues to expand to provide fully-expanded foam material 125 disposed in the cavity. Often, multiple “shots” of expandable foam formulation are used to fill the cavity, with the resulting cured shots of expanded foam material being layered on top of one another in the cavity. After the desired amount of material is dispensed and expanded, the aperture can be patched if desired. A number of methods for dispensing expandable foam formulations into building cavities are described in U.S. Patent Application Publication no. 2017/0080614, which is hereby incorporated herein by reference in its entirety. The person of ordinary skill in the art can adapt any of the methods described therein, as well as other methods for dispensing expandable foam formulation, with the metering methods, devices and systems described here.

In certain embodiments of the processes described herein, it can be desirable for multiple “shots” of expandable foam formulation to be dispensed into a single cavity. This is described, for example, in U.S. Patent Application Publication no. 2017/0080614. Accordingly, in certain embodiments as otherwise described herein, multiple cycles of actuation to begin dispensing and actuation to stop dispensing are performed, so as to dispense multiple shots of the one or more precursors into the cavity. Such multiple cycles can be performed, for example, in any manner disclosed by U.S. Patent Application Publication no. 2017/0080614. The multiple cycles can use the same predetermined volume and/or the same predetermined time, or different predetermined times and/or volumes.

The present inventors note that the expandable foam formulations and expanded foam materials described herein can be useful in insulating cavities other than building cavities. For example, the cavity can be a cavity of a refrigerator or freezer, a cavity of a cooler or ice chest, or a cavity of a beverage container. Other examples include a cavity in a vehicle, such as a car, a truck, an airplane or a boat (e.g., in a door or roof thereof); a cavity in a door (e.g., between skins of the door); and a cavity in a shell for a tub, such as a bathtub, a hottub or a spa. The person of ordinary skill in the art will appreciate that the foams of the disclosure can be used to provide insulation to a wide variety of cavities in situations where thermal insulation and/or sound control may be desired.

Another aspect of the disclosure is a kit for the production of an expanding insulating foam material as described herein. The kit includes a first part comprising all of the one or more (meth)acrylate monomers, all of the one or more epoxy monomers, and all of the one or more epoxy (meth)acrylate monomers of the expandable foam formulation; and a second part comprising all of the amine monomers of the expandable foam formulation. The first and second parts together comprise all components of the expandable foam formulation. The kit can include a first container in which the first part is provided and a second container in which the second part is provided. The components are selected such that no single container provides the totality of the reactants necessary for the foam to cure; rather, streams from the containers must be mixed to provide a curable material. Alcoholic materials such as phenol monomers and non-phenolic alcohol monomers can be provided, for example, in the second part. Thus, the methods described herein can be performed by providing such a kit, and combining the first part and the second part to provide the expandable foam formulation.

### EXAMPLES

### Example 1

In a first, proof-of-concept experiment, a commercial blend of a polyfunctional epoxy monomer and a polyfunctional acrylate monomer, EPON 8111 (Hexion, mixture of trimethylolpropane triacrylate (30-50 wt %) and bisphenol A epoxy resin (50-70%)) was reacted with a commercial hardener EPIKURE 3271 (Hexion, blend of bisphenol A (25-35%) and diethylenetriamine (50-70%)). The epoxy-acrylate blend, the amine/bisphenol A blend, a silicone surfactant (SILSTAB 2580), and a hydrofluorocarbon blowing agent (HFC 245fa, 1,1,1,3,3-pentafluoropropane), as shown in the table below:

| Material | Trade Name | Amount (g) |
|---|---|---|
| Epoxy-acrylate blend | EPON 8111 | 25 |
| Amine component | Epikure 3271 | Varied |
| HFC 245fa blowing agent | Enovate | 8 |
| Silicone surfactant | Silstab 2580 | 1 |

The epoxy-acrylate, surfactant and blowing agent were weighed out into a paper cup and mixed for several minutes by hand. The amine hardener component (i.e., the blend with bisphenol A) was weighed out in a syringe, then injected into the cup followed by hand mixing for a minute. In three test foams (Foams 1-3), amounts of hardener were 18 wt %, 36 wt % and 52 wt % of the epoxy-acrylate blend (molar ratio of 0.081:0.077:0.13-0.4 epoxy:acrylic:amine). The mixed materials were allowed to foam and cure in the cup.

Data for these initial experiments are presented in the Table below:

| | Foam 1 | Foam 2 | Foam 3 |
|---|---|---|---|
| Hardener Loading (wt % of monomer) | 18 | 36 | 52 |
| String time (min) | >20 | 6 | 2.5 |
| Cure time (min) | >20 | >20 | 4 |
| Tg (° C.) | 65.7 | 63.7 | 74.1 |

String time is the time at which long strings of tacky material can be pulled away from the surface of the foam, and acts as an estimation of gel time. Cure time is estimated as the tack-free time, i.e., the time after which the surface of the expanded foam material is no longer tacky to the touch. Glass transition temperatures were measured using differential scanning calorimetry.

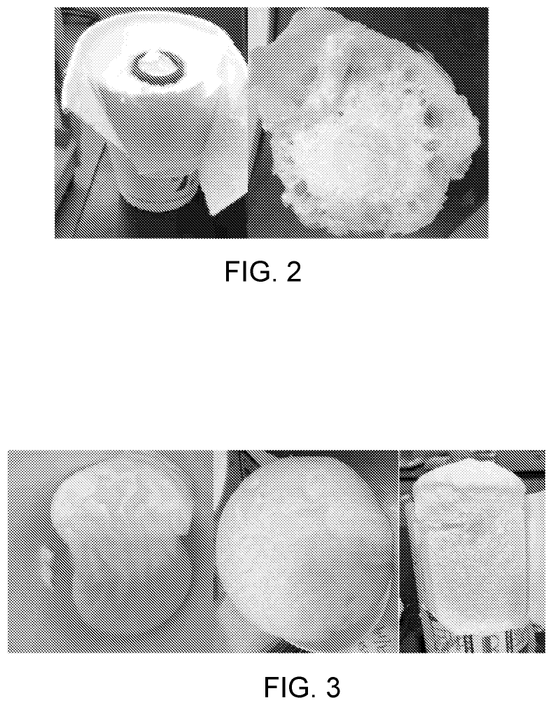

While Foam 1 was a high-quality foam, the string time and cure times were slower than for other foams. Higher doses of the hardener component provided shorter string times and shorter cure times, albeit with different foam properties using this monomer system. FIG. 2 shows pictures of Foam 1 (left) and Foam 3 (right). Foam 3 was in the form of a flat body of foam with relatively large cells. Foam 1 provided a good degree of foam rise (i.e., of formation and retention of bubbles in the foam) and only minimal shrinkage from the top of the rise.

Of course, ultimate foam properties, including rise, cure speed and material properties can be controlled via selection of the various monomers. In other experiments, different acrylate and epoxy monomers were selected to determine their impact on cure speed. In this set of experiments, the amine and phenol components were provided by EPIKURE 3271, as above. In a first set of experiments, the epoxy monomer was varied between Araldite CY 179, bisphenol A diglycidyl ether, and Araldite MY 500 (all shown below), in all cases together with tetrafunctional acrylate SR355 (Sartomer, ditrimethylolpropane tetraacrylate) with a weight ratio of acrylate to epoxy of 2:1.

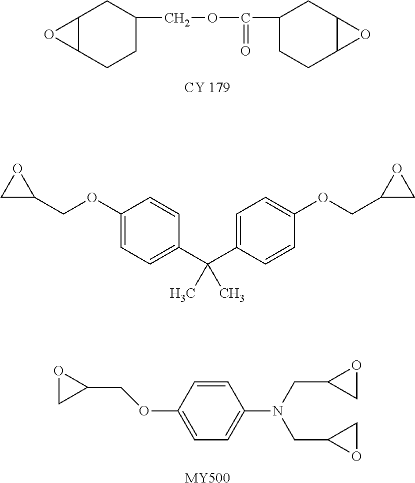

Formulations were as shown in the table below. They were mixed as described above, but using a mechanical mixer at 1500 rpm for 15 seconds.

| Material | Trade Name | Amount (g) |
|---|---|---|
| Tetra-functional acrylate | SR355 | 20 |
| Epoxy | Varied | 10 |
| Amine component | Epikure 3271 | 10 |
| HFC 245fa blowing agent | Enovate | 13 |
| Silicone surfactant | Silstab 2580 | 1.3 |

Data for these experiments are presented in the Table below:

| | Cycloaliphatic | Bisphenol A | Tri-functional |
|---|---|---|---|
| Epoxy type | epoxy | epoxy | epoxy |
| Epoxy (g) | 10 | 10 | 10 |
| Tetra-functional | 20 | 20 | 20 |
| acrylate g) | | | |
| String time (min) | 3 | 3 | 2.5 |
| Tack free time (min) | 4.5 | 7 | 4 |
| Tg (° C.) | — | 59 | 84.7 |

For these three monomers, string and tack-free times did not strongly vary. But the three samples provided foams shown in the pictures of FIG. 3, in which the epoxides used, left to right, were Araldite CY 179, bisphenol A diglycidyl ether, and Araldite MY 500. The sample based on the cycloaliphatic epoxy Araldite CY179 did exhibit some shrinkage and distortion after curing. The two phenol-based epoxide monomers provided foams with better physical properties, with the trifunctional Araldite MY 500 being the best quality of the group, with the least shrinkage and only a crack around the top of the sample. Of course, all three monomers may be suitable for foams based, e.g., on different acrylates or different amines, and may be suitable for foams for different applications.

In another set of experiments, different formulations of SR355 and Araldite MY 500 with different ratios of components were investigated. Formulations were made as described above, with the following components, in each case with 30 g total of acrylate and epoxy:

| Material | Trade Name | Amount (g) |
|---|---|---|
| Tetra-functional acrylate | SR355 | Varied |
| Tri-functional epoxy | Araldite MY 500 | Varied |
| Amine component | Epikure 3271 | 10 |
| HFC 245fa blowing agent | Enovate | 13 |
| Silicone surfactant | Silstab 2580 | 1.3 |

Foam properties of various foams, for example, pressure, foam height, shrinkage, foam temperature and timing thereof are measured using a FOAMAT® Foam Qualification System. 100 grams of expandable foam formulation is dispensed (dispense pressure ˜100 psi) into a 6″ cardboard cylinder and placed under the ultrasonic sensor of the Foam Qualification System, and data are collected from the ultrasonic sensor (foam rise height), the pressure sensor at the bottom of the cylinder (pressure), and thermocouple (temperature, metal-sheathed, ⅛″ OD thermocouple) inserted into the foam core. The foaming reaction is then monitored for at least 300 seconds.

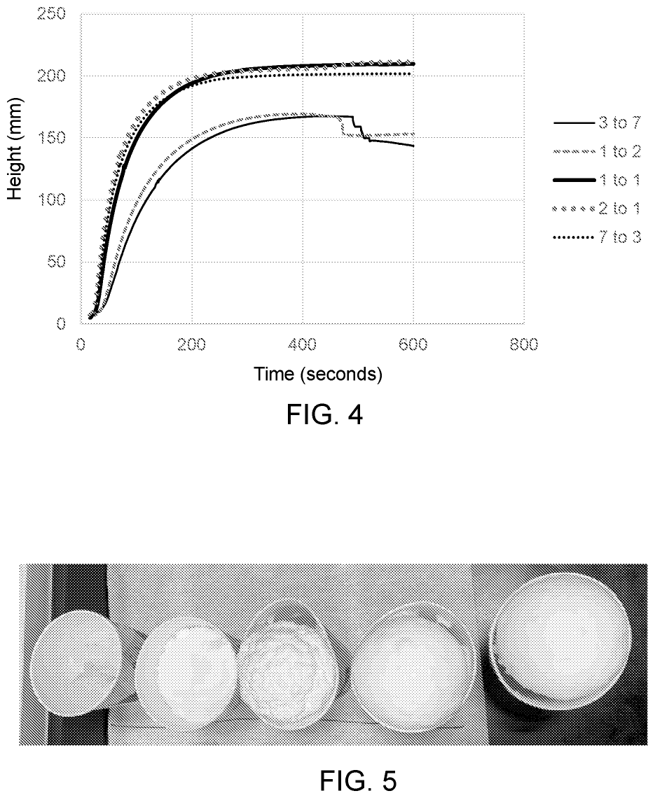

The table below provides a summary of data, FIG. 4 provides a graph of foam height vs. time, and FIG. 5 provides pictures (left-to-right, 3:7, 1:2, 1:1, 2:1 and 7:3) for foams with five different weight ratios of acrylate monomer to epoxy monomer.

| Ratio acrylate to epoxy | 3:7 | 1:2 | 1:1 | 2:1 | 7:3 |
|---|---|---|---|---|---|
| Tetra-functional acrylate (g) | 9 | 10 | 15 | 20 | 21 |
| Trifunctional epoxy (g) | 21 | 20 | 15 | 10 | 9 |
| Gel time (min) | 7 | 6 | 3.5 | 2.3 | 3 |
| Tack free time (min) | >15 | 11 | 7 | 4.7 | 4.5 |
| Tg (° C.) | — | 128.9 | 98.5 | 84.7 | 79.8 |

When relatively more acrylate than epoxy was used, the foam rose more quickly, had a higher final rise, and had better foam quality. Notably, the glass transition temperature decreased as the relative amount of acrylate increased.

Overall, these experiments demonstrate that varying identities and amounts of monomers can provide a variety of different foam properties, which can be tuned by the person of ordinary skill in the art based on the disclosure herein.

### Example 2

As noted above, a variety of different amine monomers and optional phenol monomers can be used. In this set of experiments, different amine and phenol components were used as compared to those from Example 1. Here, polyethyleneimine (Lupasol FG, branched polyethyleneimine polymer with a molecular weight ˜800 g/mol) was used as the polyfunctional amine monomer, and 4,4′-suflonyldiphenol (“sulfonyl”) and 4,4′-cyclohexylidenebisphenol (“hexyl”) were used as difunctional phenols. Formulations are summarized in the table below along with measured glass transition temperatures for resultant foams. Foam “A” was made from 25 g Epon 8111, 5 g Lupasol FG, 1 g of silicone surfactant (SILSTAB 2580) and 8 g HFC-245fa blowing agent. All formulations also included 1 g of silicone surfactant (SILSTAB 2580) and 8 g HFC-245fa blowing agent.

| Material/Property | A | B | C | D | E | F | G |
|---|---|---|---|---|---|---|---|
| Epon 8111 (g) | 25 | 25 | 25 | 25 | 25 | 25 | 25 |
| Lupasol FG (g) | 5 | 10 | 9 | 7 | 9 | 7 | 10.5 |
| Hexyl (g) | 0 | 0 | 0 | 0 | 1 | 3 | 4.5 |
| Sulfonyl (g) | 0 | 0 | 1 | 3 | 0 | 0 | 0 |
| Tg (° C.) | | 74 | 49 | — | — | 86 | 90 |

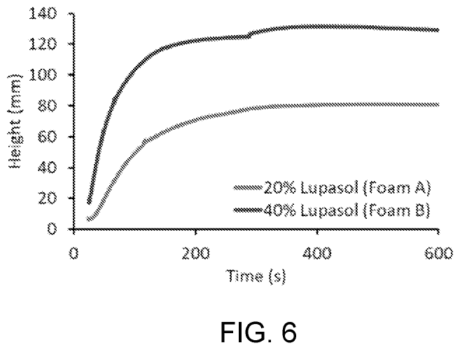

Lupasol FG in the absence of phenol was tested at two different amounts: at 20% of the mass of the EPON 8111 (Foam A), and at 40% of the mass of the EPON 8111 (Foam B). Rise time data are shown in FIG. 6.

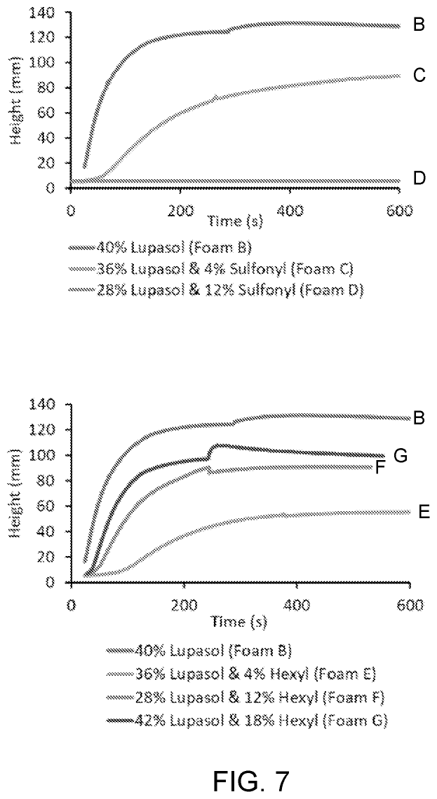

Rise time data for Foams C-G are shown in FIG. 7. The addition of phenol tended to slow the rise rate of the foam. The sulfonyl phenol had more of an impact on rise rate than did the hexyl activator. Without intending to be bound by theory, the inventors surmise that the increased acidity of the sulfonylphenol causes more of the amine present in the formulation to be present as ammonium, which is less reactive in the Michael addition, thus slowing down overall rate, despite the fact that the phenol also activates addition to the epoxy. The discontinuities in the rise time data for Foams F and G was due to cracking within the foam causing the sample cup to move. The glass transition temperature data in the table above indicate that the phenols can also have a significant effect on foam mechanical properties, providing the person of ordinary skill in the art another way to tune foam properties.

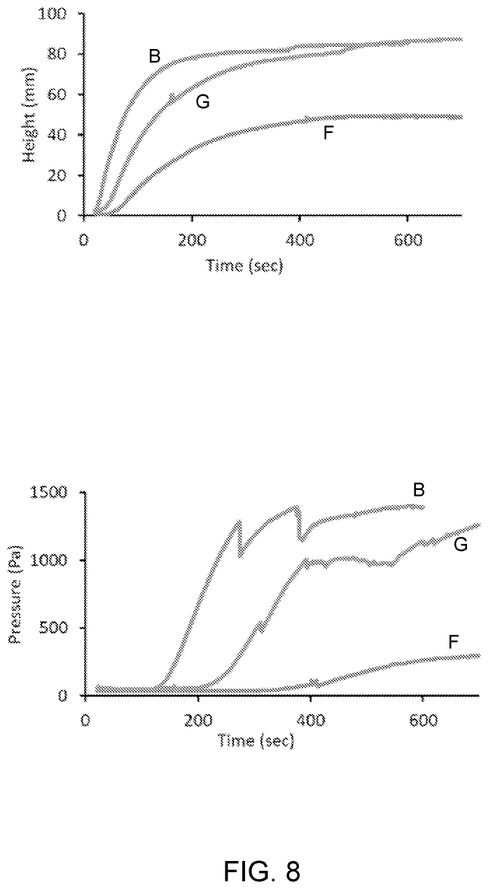

Larger batches of a few such materials (Foams B, F and G) were made, and tested using the FOAMAT apparatus as described above. Rise time and pressure data are shown in FIG. 8. The rise rates of the foams followed the same trend as described above. Each foam had a single large crack along its bottom.

Advantageously, both phenol monomers used here have relatively benign health and safely profiles.

### Example 3

In another set of experiments, use of a different polyethyleneimine, PEI 1200 from Polysciences, was investigated. The Lupasol FG is compared with the PEI 1200:

| | 1°:2°:3° | Amine equivalent weight (by |
|---|---|---|
| | amine ratio | titration) mol amine/g sample |
| Lupasol FG (BASF) | 1:0.9:0.5 | 0.016 |
| PEI 1200 | 1:2:1 | 0.015 |
| (Polysciences) | | |

Moreover, the health and safety warnings on PEI 1200 were less severe than those for Lupasol FG. Two formulations were prepared (amounts in g):

| Trade Name | Role | H | I |
|---|---|---|---|
| EPON 8111 | Preblended epoxy-acrylate | 25 | 25 |
| Silstab 2580 | Closed cell silicone surfactant | 1 | 1 |
| Enovate | HFC 245fa blowing agent | 8 | 8 |
| Lupasol FG | Polyethyleneimine | 10 | 0 |
| PEI 1200 | Polyethyleneimine | 0 | 10 |

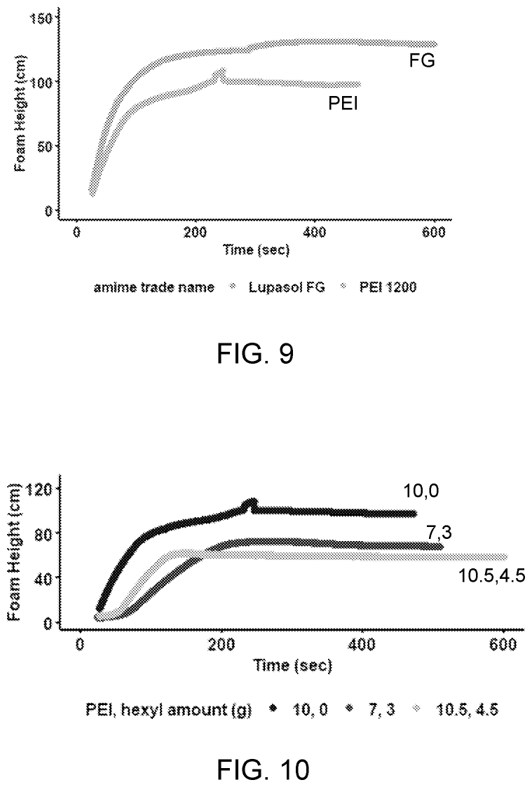

Foam height data are shown in FIG. 9. In terms of performance, both polyethyleneimine foam formulations exhibited some degree of cracking. The foam made with PEI 1200 had more cracks along the top, while the top of foam made with Lupasol FG almost completely popped off due to a horizontal crack. The Lupasol FG-based foam exhibited the faster rise and higher final height, as shown in FIG. 9 compared to the PEI 1200-based foam; without intending to be bound by theory, the present inventors surmise that this may be due to the relatively greater concentration of primary amines in the Lupasol FG.

Formulations were made using the PEI 1200 polyethyleneimine and the hexyl phenol described above (amounts in g).

| Trade Name | Role | J | K | L |
|---|---|---|---|---|
| EPON 8111 | Preblended epoxy-acrylate | 25 | 25 | 25 |
| Silstab 2580 | Closed cell silicone surfactant | 1 | 1 | 1 |
| Enovate | HFC 245fa blowing agent | 8 | 8 | 8 |
| PEI 1200 | Polyethyleneimine | 10 | 7 | 10.5 |
| “hexyl” | 4,4-Cyclohexylidenebisphenol | 0 | 3 | 4.5 |

Rise time data are provided in FIG. 10. The hexyl activator slowed rise time, but cured foams using it were of good quality, without evident cracking. In this system, use of the sulfonyl activator instead of the hexyl activator in high quantities prevented foam formation.

Thus, the inventors have determined that crack-free, HSE-friendly foams with a rise time (˜3 minutes) desirable for use in spray insulation foams can be prepared using the chemistry described herein.

### Example 4

It can be desirable in many applications for a foam material to be flame-retardant. For example, a common insulation rating for foam insulation materials is the ASTM E84 Class A rating. In conventional foams, large concentrations of flame retardants are often necessary to meet the flame standard, which can have significant impact on mechanical properties.

A number of liquid flame retardants were incorporated into a series of foams, and the flammability of the foams was estimated with the UL94 HBF test. Though this laboratory test is significantly less severe than the full-scale ASTM E84 test, it is readily available and small in sample size. In this test, a 40 mm flame is placed on one end of the sample and allowed to burn for 60 seconds. The flame can spread along the sample and the steady state burn rate can be determined if the sample does not self-extinguish. The person of ordinary skill in the art will appreciate that that samples with very low flame propagation rates or near-immediate self-extinguishment in the HBF test will have promising fire performance in the full-scale E84 test.

Specifically, samples are cut from the foams at 3-4 mm thickness and as close to 200 mm long by 50 mm wide. Two lines are drawn on the foam at 25 mm and 125 mm from a first end of the strip. The foam is then placed on a wire mesh. The flame is adjusted to align with the first end of the sample adjacent the 25 mm line. The 40 mm mostly blue flame is placed on the edge of the sample for 60 seconds. As the sample burns, a second timer is started as soon as the flame touches the 25 mm line, and stopped when flame reaches the 125 mm line or self-extinguishes.

To calculate the steady state burn rate, the flame spread (burn length and afterflame time) is measured between the 25 and 125 mm marks because the flame spread will have stabilized after ignition. When the flame front does not pass the 25 mm line, the burn rate cannot be calculated.

$${R}_{b} = ( \frac{{D}_{ss}}{{t}_{ss}} ) * 60$$

Dₛₛ is the distance in millimeters that the flame burned along the sample's length at steady state within a 100 mm distance. tₛₛ is the time in seconds from when the flame front passes the 25 mm mark until the flame either self-extinguishes or passes the 125 mm mark. R_{b} is the speed in millimeters per minute at which the flame front moved at steady state.

A variety of formulations were prepared:

| Trade Name | Role | M | N | O | P | Q |
|---|---|---|---|---|---|---|
| EPON 8111 | Preblended epoxy-acrylate | 50 | 50 | 50 | 50 | 50 |
| Silstab 2580 | Closed cell silicone surfactant | 2 | 2 | 2 | 2 | 2 |
| Enovate | HFC 245fa blowing agent | 16 | 16 | 16 | 16 | 16 |
| PEI 1200 | Polyethyleneimine | 21 | 21 | 21 | 21 | 21 |
| Hexyl | 4,4-Cyclohexylidenebisphenol | 9 | 9 | 9 | 9 | 9 |
| PHT4diol LV | Reactive bromine FR | 0 | 20 | 0 | 0 | 0 |
| Fyrolflex PCF | TCPP, non-reactive | 0 | 0 | 5 | 0 | 0 |
| | phosphate FR | | | | | |
| Fyrolflex RDP | Non-reactive phosphate FR | 0 | 0 | 0 | 10 | 0 |
| SaFRon 6605 | TCPP + bromine FR | 0 | 0 | 0 | 0 | 15 |

PHT4-diol (Chemtura) is a reactive, alcohol-functional brominated liquid; its reactive alcohol functionality allows for reaction with epoxy and prevents potential migration of the compound under normal conditions. Another reactive alcohol-functional brominated liquid is available from Albemarle under the designation RB-49. TCPP is tris(1-chloroprop-2-yl) phosphate, a non-reactive phosphate fire retardant, available under the tradename Fyroflex PCF. Fyroflex RDP is a bisphosphate analog of TCPP. TCPP and reactive brominated alcohols are often used in combination in polyurethane foams. SaFRon 6605 is sold by ICL-IP and is a blend of TCPP and OH-functional tribromoneopentyl alcohol. The table below provides testing results:

| | | | foam | UL94 HBF | Weight | |
|---|---|---|---|---|---|---|
| Flame | | | quality | burn rate | Percent | Tg |
| retardant | Type | Reactive | impact | (mm/min) | FR | (° C.) |
| No FR | N/A | N/A | N/A | 100 | 0 | 86.4 |
| PHT4-diol | Br | yes | none | 103 | 16.9 | 69.8 |
| TCPP | phosphate | no | significant | 58 | 4.9 | 77.0 |
| RDP | phosphate | no | significant | N/A | 9.3 | 84.3 |
| SaFRon | Br/phosphate | Br - yes | none | 36 | 13.3 | 76.6 |
| 6605 | | | | | | |

Significant amounts of the PHT4-diol can be incorporated into the system without ruining the foam structure (visual examination) or rigidity (i.e. limited reduction in T_{g}), but in this experiment there was no significant impact on the foam flammability. TCPP can make a noteworthy reduction in flammability, but the phosphate has a significant plasticizing impact, and only 4.9 wt % TCPP was added before the foam structure degraded significantly. Similarly, RDP was heavily plasticizing, and no samples could be made large enough to perform fire testing on. SaFRon 6605 worked well in this reaction system, given both the reduction in flammability and minimal impact on glass transition temperature.

In another set of experiments, formulations according to the Table below were made with various flame retardants. Epoxy-acrylate, surfactant and blowing agent were weighed out into a paper cup and mixed for several minutes. The amine component was weighed out in a syringe. To start the reaction, the amine was applied to the paper cup and mixed using a mechanical mixer for 15 seconds at 1500 rpm.

| Component | Role | Amount (g) |
|---|---|---|
| EPON 8111 | Pre-blended epoxy-acrylate | 50 |
| Silstab 2580 | Closed cell silicone surfactant | 2 |
| Opteon 1100 | HFO blowing agent | 7 |
| Opteon 1150 | HFO blowing agent | 7 |
| Flame retardant | | Varies |
| PEI 1200 | Amine | 21 |
| 4,4′-Cyclohexylidene | Bisphenol activator | 9 |
| bisphenol | | |

Flame test and Tg data for various formulations are provided in the table below:

| | | | Average | | |
|---|---|---|---|---|---|
| | | | burn rate | Self- | Tg |
| FR | Loading | Description | (mm/min) | extinguish? | (° C.) |
| No FR | | | 100.8 | No | 86.4 |
| TCPP | 5 | Non-reactive | 57.8 | No | 77.0 |
| | | phosphate FR | | | |
| RDP | 5 | Non-reactive | 110.8 | No | 79.1 |
| | | phosphate FR | | | |
| PNX | 5 | Non-reactive | 105.2 | No | 79.7 |
| | | phosphate | | | |
| OP560 | 20 | Reactive | 30.51 | No | 80.6 |
| | | phosphate FR | | | |
| Fyrol 6 | 20 | Reactive | 53.6 | No | 72.8 |
| | | phosphate FR | | | |
| SaFRon | 30 | phosphate/ | 28.6 | No | 70.1 |
| | | reactive | | | |
| | | bromine FR | | | |
| PHT4diol | 20 | Reactive | 103.8 | No | 69.8 |
| | | bromine FR | | | |

Fyrol PNX (ICL) is a non-reactive alkylphosphate oligomer. Exolit OP 560 (Clariant) is an alcohol-functional phosphonate oligomer. Fryol 6 (ICL) is an alcohol-functional phosphonate oligomer. Other materials are as described above.

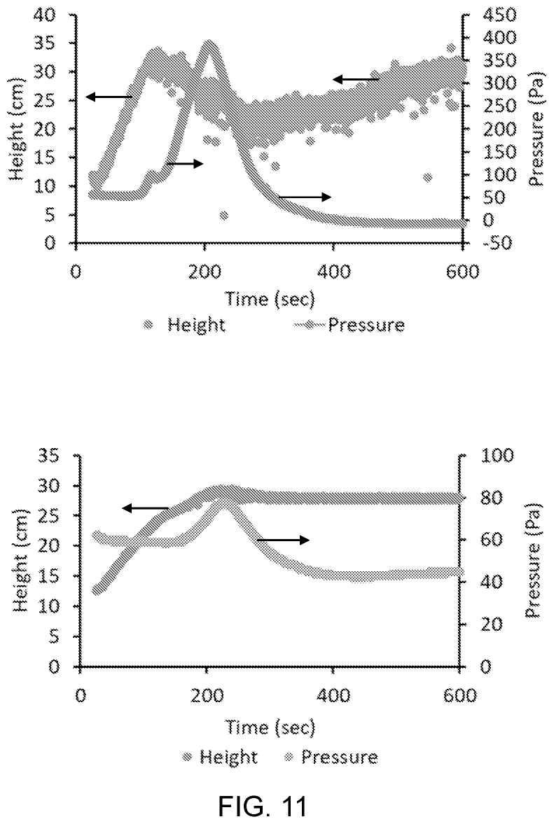

Foam height and pressure as a function of time are provided in FIG. 11 for two OP560-containing formulations. The top graph provides data for a formulation as described in the tables above with 20 grams of OP560 as flame retardant, and the bottom graph provides data for a formulation with 30 grams of OP560 as flame retardant.

In the formulation tested, conventional small molecule flame retardants like TCPP and RDP were compatible at relatively low loadings (e.g., 5 grams per 50 grams EPON 8111. The reactive flame retardants could be added in much higher loadings (e.g., 20-30 grams per 50 grams EPON 8111). Foams including OP560 and SaFRon exhibited the lowest burn rate and best quality foam.

In another experiment a similar formulation was prepared, replacing the EPON 8111 (difunctional epoxy and tetrafunctional acrylate) with a combination of a tri-functional epoxy and a tetra-functional acrylate, as in the table below:

| | | Amount |
|---|---|---|
| Component | Role | (g) |
| Araldite MY 0500 | Tri-functional epoxy | 32 |
| SR 355 | Tetra-functional acrylate | 16 |
| Silstab 2580 | Closed cell silicone surfactant | 2 |
| Opteon 1100 | HFO blowing agent | 7 |
| Opteon 1150 | HFO blowing agent | 7 |
| OP560 | Flame retardant | 30 |
| PEI 1200 | Amine | 21 |
| 4,4′-Cyclohexylidene | Bisphenol activator | 9 |
| bisphenol | | |

In the fire test, this material self-extinguished in UL94 HBF test. Without intending to be bound by theory, the inventors surmise that this increased fire performance is a result of the increased crosslink density of this material.

Various non-limiting aspects and embodiments of the disclosure are provided by the following enumerated embodiments, which can be combined in any number and in any combination not technically or logically inconsistent.

Embodiment 1. An expandable foam formulation, the expandable foam formulation being expandable and curable to provide an expanded foam material, the expandable foam formulation comprising:
one or more (meth)acrylate and/or epoxy monomers, each selected from
   one or more (meth)acrylate monomers,
   one or more epoxy monomers, and
   one or more epoxy (meth)acrylate monomers,
   provided that if no epoxy (meth)acrylate monomer is present, both of one or more (meth)acrylate monomers and one or more epoxy monomers are present;
one or more primary amine monomers; and
optionally, a blowing agent,
   wherein if no epoxy (meth)acrylate monomer is present, two or more of a (meth)acrylate monomer, an epoxy monomer and a primary amine monomer are polyfunctional.

Embodiment 2. The expandable foam formulation according to embodiment 1, wherein the one or more (meth)acrylate monomers comprise at least one polyfunctional (meth)acrylate monomer.

Embodiment 3. The expandable foam formulation according to embodiment 1, wherein the one or more (meth)acrylate monomers comprise at least one trifunctional (meth)acrylate monomer.

Embodiment 4. The expandable foam formulation according to any of embodiments 1-3, wherein the one or more (meth)acrylate monomers comprise a difunctional methacrylate monomer, a trifunctional (meth)acrylate monomer, a tetrafunctional (meth)acrylate monomer, and/or a pentafunctional (meth)acrylate monomer.

Embodiment 5. The expandable foam formulation according to any of embodiments 1-4, wherein at least one of (e.g., each of) the one or more (meth)acrylate monomers has a weight-average molecular weight in the range of 170 g/mol to 2000 g/mol, e.g., in the range of 170-1500 g/mol, or 170-1000 g/mol, or 170-700 g/mol, or 250-2000 g/mol, or 250-1500 g/mol, or 250-1000 g/mol, or 250-700 g/mol.

Embodiment 6. The expandable foam formulation according to any of embodiments 1-5, wherein at least one of (e.g., each of) the one or more (meth)acrylate monomers has a weight-average molecular weight in the range of 2,000 g/mol to 200,000 g/mol, e.g., in the range of 2,000-100,000 g/mol, or 2,000-50,000 g/mol, or 2,000-20,000 g/mol, or 10,000-200,000 g/mol, or 10,000-100,000 g/mol, or 10,000-50,000 g/mol, or 20,000-200,000 g/mol.

Embodiment 7. The expandable foam formulation according to any of embodiments 1-6 wherein the one or more (meth)acrylate monomers comprise one or more of trimethylolpropane tri(meth)acrylate; ethylene glycol di(meth)acrylate; 1,6-hexanedioldi(meth)acrylate; pentaerythritol tetra(meth)acrylate; dipentaerythritol pentaacrylate; 3-methyl-1,5-pentanediol di(meth)acrylate; dipentaerythritol penta(meth)acrylate; and bisphenol A di(meth)acrylate.

Embodiment 8. The expandable foam formulation according to any of embodiments 1-7 wherein the one or more (meth)acrylate monomers comprise one or more of a polyether poly(meth)acrylate monomer (e.g., di(ethylene glycol) di(meth)acrylate, tri(ethylene glycol) di(meth)acrylate, poly(ethylene glycol) di(meth)acrylate, poly(propylene glycol) di(meth)acrylate and poly(ethylene glycol-co-propylene glycol) di(meth)acrylate; polyester poly(meth)acrylate monomers and silicone poly(meth)acrylate monomers.

Embodiment 9. The expandable foam formulation according to any of embodiments 1-8 wherein the one or more (meth)acrylate monomers comprise one or more urethane poly(meth)acrylate monomers and/or one or more urea poly(meth)acrylate monomers.

Embodiment 10. The expandable foam formulation according to any of embodiments 1-9, the one or more (meth)acrylate monomers include one or more monofunctional (meth)acrylate monomers selected from alkyl (meth)acrylates (e.g., 2-ethylhexyl (meth)acrylate and lauryl (meth)acrylate); ethoxylated alkylphenol (meth)acrylate; phenoxyethyl (meth)acrylate; 2-(2-ethoxyethoxy) ethyl (meth)acrylate; and poly(ethylene glycol) mono(meth)acrylate.

Embodiment 11. The expandable foam formulation according to any of embodiments 1-10, wherein one or more of (e.g., each of) the one or more (meth)acrylate monomers is an acrylate monomer.

Embodiment 12. The expandable foam formulation according to any of embodiments 1-11, wherein the one or more polyfunctional (meth)acrylate monomers are present in a total amount in the range of 10-80 wt %, e.g., in the range of 10-70 wt %, or 10-60 wt %, or 10-50 wt %, or 20-80 wt %, or 20-70 wt %, or 20-60 wt %, or 20-50 wt %.

Embodiment 13. The expandable foam formulation according to any of embodiments 1-12, wherein the one or more epoxy monomers comprise at least one polyfunctional epoxy monomer.

Embodiment 14. The expandable foam formulation according to any of embodiments 1-13, wherein the one or more epoxy monomers comprise a trifunctional epoxy monomer.

Embodiment 15. The expandable foam formulation according to any of embodiments 1-14, wherein the one or more epoxy monomers comprise a difunctional epoxy monomer, a tetrafunctional epoxy monomer, and/or a pentafunctional epoxy monomer.

Embodiment 16. The expandable foam formulation according to any of embodiments 1-15, wherein at least one of the one or more epoxy monomers has a weight-average molecular weight in the range of 174 g/mol to 2000 g/mol, e.g., in the range of 174-1500 g/mol, or 174-1000 g/mol, or 174-700 g/mol, or 250-2000 g/mol, or 250-1500 g/mol, or 250-1000 g/mol, or 250-700 g/mol.

Embodiment 17. The expandable foam formulation according to any of embodiments 1-16, wherein at least one of the one or more epoxy monomers has a weight-average molecular weight in the range of 2,000 g/mol to 200,000 g/mol, e.g., in the range of 2,000-100,000 g/mol, or 2,000-50,000 g/mol, or 2,000-20,000 g/mol, or 10,000-200,000 g/mol, or 10,000-100,000 g/mol, or 10,000-50,000 g/mol, or 20,000-200,000 g/mol.

Embodiment 18. The expandable foam formulation according to any of embodiments 1-17, wherein the one or more polyfunctional epoxy monomers comprise one or more of bisphenol A diglycidyl ether; ethylene glycol diglycidyl ether; 1,ω alkanediol diglycidyl ethers;

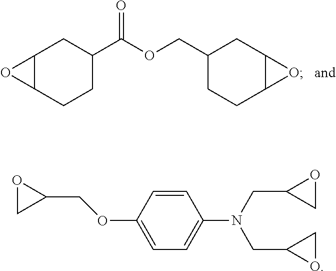 [SMILES: O=C(OCC1CCC2OC2C1)C1CCC2OC2C1 ; "and" ; c1cc(N(CC2CO2)CC2CO2)ccc1OCC1CO1]

Embodiment 19. The expandable foam formulation according to any of embodiments 1-18 wherein the one or more epoxy monomers comprise one or more of an epoxy-functional polyether monomer (e.g., di(ethylene glycol) diglycidyl ether, tri(ethylene glycol) diglycidyl ether, poly(ethylene glycol) diglycidyl ether and poly(propylene glycol) diglycidyl ether); an epoxy-functional polyester monomer and an epoxyfunctional silicone monomer (e.g., epoxypropoxypropyl)dimethoxysilyl-terminated polydimethylsiloxane).

Embodiment 20. The expandable foam formulation according to any of embodiments 1-19 wherein the one or more epoxy monomers comprise one or more epoxy-functional urethane monomers and/or one or more epoxy-functional urea monomers.

Embodiment 21. The expandable foam formulation according to any of embodiments 1-20, the one or more epoxy monomers include one or more monofunctional epoxy monomers selected from alkyl epoxides (e.g., 1,2-epoxyheptane), tert-butyl glycidyl ether, 1,2-epoxycyclohexane, glycidyl 2-methoxyphenyl ether, 2,4-dibromoglycidyl ether, and polyethylene glycol glycidyl lauryl ether.

Embodiment 22. The expandable foam formulation according to any of embodiments 1-21 wherein the one or more epoxy monomers are present in a total amount in the range of 10-80 wt %, e.g., in the range of 10-70 wt %, or 10-60 wt %, or 10-50 wt %, or 20-80 wt %, or 20-70 wt %, or 20-60 wt %, or 20-50 wt %.

Embodiment 23. The expandable foam formulation according to any of embodiments 1-22, wherein no epoxy (meth)acrylate monomer is present.

Embodiment 24. The expandable foam formulation according to any of embodiments 1-22, wherein one or more epoxy (meth)acrylate monomers are present.

Embodiment 25. The expandable foam formulation according to embodiment 24, wherein the one or more epoxy (meth)acrylate monomers comprise one or more of glycidyl (meth)acrylate and 1-(2-(glycidyloxy)ethoxy)ethyl methacrylate.

Embodiment 26. The expandable foam formulation according to embodiment 24 or embodiment 25, wherein the each of the one or more epoxy (meth)acrylate monomers is an epoxy acrylate monomer.

Embodiment 27. The expandable foam formulation according to any of embodiments 24-26, wherein the one or more epoxy (meth)acrylate monomers are present in a total amount in the range of 10-80 wt %, e.g., in the range of 10-70 wt %, or 10-60 wt %, or 10-50 wt %, or 20-80 wt %, or 20-70 wt %, or 20-60 wt %, or 20-50 wt %.

Embodiment 28. The expandable foam formulation according to any of embodiments 1-27, wherein the one or more primary amine monomers comprise at least one polyfunctional primary amine monomer.

Embodiment 29. The expandable foam formulation according to any of embodiments 1-28, wherein the one or more primary amine monomers comprise one or more primary amines having a number-average functionality of at least 10 primary amines/mol, e.g., at least 20 primary amines/mol.

Embodiment 30. The expandable foam formulation according to any of embodiments 1-29, wherein the one or more primary amine monomers comprise one or more primary amines having a number-average functionality of 2-10 primary amines/mol, e.g., 2-5 primary amines/mol.

Embodiment 31. The expandable foam formulation according to any of embodiments 1-30, wherein the one or more primary amine monomers comprise one or more monofunctional primary amines.

Embodiment 32. The expandable foam formulation according to embodiment any of embodiments 1-31, wherein at least one of (e.g., each of) the one or more primary amine monomers has a weight-average molecular weight in the range of 103 g/mol to 50000 g/mol, e.g., in the range of 103-25000 g/mol, or 103-10000 g/mol, or 103-2500 g/mol, or 103-1000 g/mol, or 500-50000 g/mol, or 500-25000 g/mol, or 500-10000 g/mol, or 500-2500 g/mol, or 1000-50000 g/mol, or 1000-25000 g/mol, or 1000-10000 g/mol, or 1000-2500 g/mol.

Embodiment 33. The expandable foam formulation according to any of embodiments 1-32, wherein the one or more primary amine monomers comprise a primary amine-bearing oligomer or polymer, for example, a polyethyleneimine.

Embodiment 34. The expandable foam formulation according to embodiment 33, wherein the primary amine-bearing polymer (e.g., the polyethyleneimine) has a weight-average molecular weight in the range of 500 g/mol to 10000 g/mol, e.g., in the range of 500-8000 g/mol, or 500-6000 g/mol, or 1000-10000 g/mol, or 1000-8000 g/mol, or 1000-6000 g/mol.

Embodiment 35. The expandable foam formulation according to any of embodiments 1-34, wherein the one or more primary amine monomers comprise diethylenetriamine.

Embodiment 36. The expandable foam formulation according to any of embodiments 1-35, wherein the one or more primary amine monomers include one or more of 4,4-bis(aminomethyl) toluene, 2,5-bis(aminomethyl)-p-xylene, bis(aminomethyl) durene, 2,4-bis(aminoethyl)-1,3,5-triisopropylbenzene, triethylene tetraamine, tetraethylene pentaamine, isophorone diamine, bis-paraaminocyclohexyl methane, 1,2-diaminocyclohexane (1,2-DACH), alkylamines such as 1,6-hexanediamine, 1,8-octanediamine, and 1,10-decanediamine, etheramines such as 1,2-bis-(aminopropoxy) ethane, 1,3-bis-(3-aminopropoxy) propane and 2,2-dimethyl-1,3-bis(3-aminopropoxy) propane, and amidoamines.

Embodiment 37. The expandable foam formulation according to any of embodiments 1-36 wherein the one or more primary amine monomers are present in a total amount in the range of 5-50 wt %, e.g., in the range of 5-40 wt %, or 5-30 wt %, or 5-20 wt %, or 10-50 wt %, or 10-40 wt %, or 10-30 wt %.

Embodiment 38. The expandable foam formulation according to any of embodiments 1-37, wherein the molar ratio of primary amine moieties of the one or more primary amine monomers to (meth)acrylate moieties of the one or more (meth)acrylate monomers and the one or more epoxy (meth)acrylate monomers in the expandable foam formulation is at least 1:2, e.g., at least 1:1.5.

Embodiment 39. The expandable foam formulation according to any of embodiments 1-37, wherein the molar ratio of primary amine moieties of the one or more primary amine monomers to (meth)acrylate moieties of the one or more (meth)acrylate monomers and the one or more epoxy (meth)acrylate monomers in the expandable foam formulation is at least 1:1.1, or at least 1:1.05, or at least 1:1.

Embodiment 40. The expandable foam formulation according to any of embodiments 1-39, wherein the molar ratio of primary amine moieties of the one or more primary amine monomers to (meth)acrylate moieties of the one or more (meth)acrylate monomers and the one or more epoxy (meth)acrylate monomers in the expandable foam formulation is in the range of 4:1 to 1:2, e.g., in the range of 4:1 to 1:1.5, or 4:1 to 1:1.1, or 4:1 to 1:1.05, or 4:1 to 1:1, or 3:1 to 1:2, or 3:1 to 1:1.5, or 3:1 to 1:1.1, or 3:1 to 1:1.05, or 3:1 to 1:1.

Embodiment 41. The expandable foam formulation according to any of embodiments 1-39, wherein the molar ratio of primary amine moieties of the one or more primary amine monomers to (meth)acrylate moieties of the one or more (meth)acrylate monomers and the one or more epoxy (meth)acrylate monomers in the expandable foam formulation is in the range of 2:1 to 1:2, e.g., 2:1 to 1:1.5, or 2:1 to 1:1.1, or 2:1 to 1:1.05, or 2:1 to 1:1, or 1.5:1 to 1:2, or 1.5:1 to 1:1.5, or 1.5:1 to 1:1.1, or 1.5:1 to 1:1.05, or 1.5:1 to 1:1.

Embodiment 42. The expandable foam formulation according to any of embodiments 1-41, wherein the molar ratio of primary amine moieties to epoxy moieties in the expandable foam formulation is in the range of 4:1 to 1:4, e.g., in the range of 4:1 to 1:3, or 4:1 to 1:2, or 4:1 to 1:1.2, or 4:1 to 1:1, or 3:1 to 1:4, or 3:1 to 1:3, or 3:1 to 1:2, or 3:1 to 1:2, or 3:1 to 1:1, or 2:1 to 1:4, or 2:1 to 1:3, or 2:1 to 1:2, or 2:1 to 1:1.2, or 2:1 to 1:1, or 1.2:1 to 1:4, or 1.2:1 to 1:3, or 1.2:1 to 1:2, or 1.2:1 to 1:1.2, or 1.2:1 to 1:1.

Embodiment 43. The expandable foam formulation according to any of embodiments 1-41, wherein the molar ratio of primary amine moieties to the sum of the molar ratio of epoxy moieties and the molar ratio of (meth)acrylate moieties is no more than 1.5:1, e.g., no more than 1.1:1, or no more than 1.05:1, or no more than 1:1.

Embodiment 44. The expandable foam formulation according to any of embodiments 1-41, wherein the molar ratio of primary amine moieties to the sum of the molar ratio of epoxy moieties and the molar ratio of (meth)acrylate moieties is in the range of 1.5:1 to 1:4, e.g., 1.5:1 to 1:3, or 1.5:1 to 1:2, or 1.5:1 to 1:1.5, or 1.1:1 to 1:4, or 1.1:1 to 1:3, or 1.1:1 to 1:2, or 1.1:1 to 1:1.5, or 1.05:1 to 1:4, or 1.05:1 to 1:3, or 1.05:1 to 1:2, or 1.05:1 to 1:1.5, or 1:1 to 1:4, or 1:1 to 1:3, or 1:1 to 1:2, or 1:1 to 1:1.5.

Embodiment 45. The expandable foam formulation according to any of embodiments 1-44, wherein the blowing agent is present.

Embodiment 46. The expandable foam formulation according to any of embodiments 1-45, wherein the one or more blowing agents include one or more hydrofluoroolefin blowing agents.

Embodiment 47. The expandable foam formulation according to any of embodiments 1-46, wherein the one or more blowing agents include one or more of cis-1,1,1,4,4,4-hexafluoro-2-butene (OPTEON 1100) and trans-1,1,1,4,4,4-hexafluoro-2-butene (OPTEON 1150).

Embodiment 48. The expandable foam formulation according to any of embodiments 1-47, wherein the one or more blowing agents include 1,3,3,3-tetrafluoropropene (HFO-1234ze)

Embodiment 49. The expandable foam formulation according to any of embodiments 1-48, wherein the one or more blowing agents include one or more volatile hydrocarbons (e.g., butane, pentane).

Embodiment 50. The expandable foam formulation according to any of embodiments 1-49, wherein the one or more blowing agents are present in an amount in the range of 5 wt % to 30 wt %, e.g., 5-25 wt %, or 5-20 wt %, or 5-15 wt %, or 10-30 wt %, or 10-25 wt %, or 10-20 wt %, or 15-30 wt %, or 15-25 wt %.

Embodiment 51. The expandable foam formulation according to any of embodiments 1-44, wherein the blowing agent is not present.

Embodiment 52. The expandable foam formulation according to any of embodiments 1-51, further comprising one or more phenols.

Embodiment 53. The expandable foam formulation according to embodiment 52, wherein the one or more phenols include one or more polyfunctional phenols, e.g., one or more difunctional phenols, one or more trifunctional phenols and/or one or more tetrafunctional phenols.

Embodiment 54. The expandable foam formulation according to embodiment 52 or embodiment 53, wherein at least one of the one or more phenols has a weight-average molecular weight in the range of 228 g/mol to 2000 g/mol, e.g., in the range of 228-1500 g/mol, or 228-1000 g/mol, or 228-700 g/mol.

Embodiment 55. The expandable foam formulation according to any of embodiments 52-54, wherein the one or more phenols comprise one or more Bisphenols.

Embodiment 56. The expandable foam formulation according to any of embodiments 52-55, wherein the one or more phenols comprise one or more of Bisphenol A and Bisphenol Z (23,24,25,26-tetrahydro-22H-[11,21:21,31-terphenyl]-14,34-diol).

Embodiment 57. The expandable foam formulation according to any of embodiments 52-56, wherein the one or more phenols comprise one or more of Bisphenol AP, Bisphenol AF, Bisphenol B, Bisphenol BP, Bisphenol C, Bisphenol C2, Bisphenol E, Bisphenol F, Bisphenol G, Bisphenol M, Bisphenol S, Bisphenol P, Bisphenol PH, Bisphenol TMC, dinitrobisphenol A and tetrabromobisphenol A.

Embodiment 58. The expandable foam formulation according to any of embodiments 52-57, wherein the one or more phenols include one or more halogenated phenols, e.g., one or more halogenated polyfunctional phenols.

Embodiment 59. The expandable foam formulation according to embodiment 58, wherein the halogenation of the halogenated phenols is chlorination or bromination (e.g., tribromophenol).

Embodiment 60. The expandable foam formulation according to any of embodiments 52-59, wherein the one or more phenols are present in a total amount up to 20 wt %, e.g., up to 15 wt %, or up to 10 wt %, or in the range of 1-20 wt %, or 1-15 wt %, or 1-10 wt %, or 2-20 wt %, or 2-15 wt %, or 2-10 wt %, or 5-20 wt %, or 5-15 wt %, or 5-10 wt %.

Embodiment 61. The expandable foam formulation according to any of embodiments 1-60, further comprising one or more non-phenolic alcohols.

Embodiment 62. The expandable foam formulation according to embodiment 61, wherein the one or more non-phenolic alcohols include one or more polyfunctional (e.g., difunctional) non-phenolic alcohols.

Embodiment 63. The expandable foam formulation according to embodiment 61 or embodiment 62, wherein the one or more non-phenolic alcohols comprise one or more monofunctional non-phenolic alcohols.

Embodiment 64. The expandable foam formulation according to any of embodiments 61-63, wherein the one or more non-phenolic alcohols comprise one or more non-phenolic alcohol flame retardants.

Embodiment 65. The expandable foam formulation according to any of embodiments 61-64, wherein the one or more non-phenolic alcohols comprise one or more phosphorus-including alcohols (e.g., phosphates and/or phosphonates).

Embodiment 66. The expandable foam formulation according to any of embodiments 61-65, wherein the one or more non-phenolic alcohols comprise one or more of diethyl N, N-bis(2-hydroxyethyl) aminomethylphosphonate (Fyrol 6, also Lanxess 4090N); diethyl (hydroxymethyl)phosphonate;

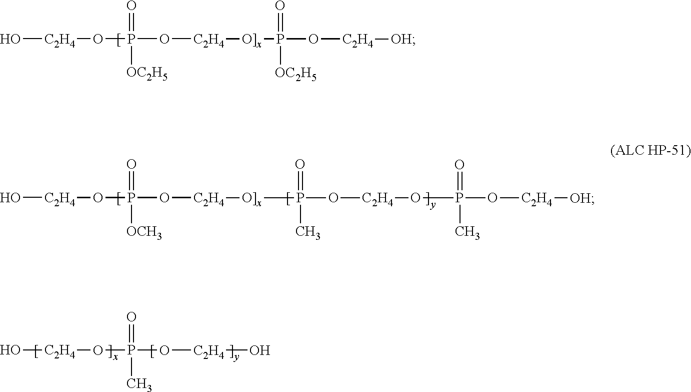

(EXOLIT OP 560); EXOLIT OP 550 (Phosphate ester with hydroxyalkyl groups having the following properties: phosphorus content: 17.0%; hydroxyl value: 130 KOHmg/g; acid value: 1.3 KOH mg/g; viscosity (25° C.): 2.1 Pas; weight average molecular weight: 863 g/mol); and SAFRON 6600 series materials (alcohol-functional phosphonate).

Embodiment 67. The expandable foam formulation according to any of embodiments 61-66, wherein the one or more non-phenolic alcohols comprise one or more halogenated alcohols (e.g., chlorinated and/or brominated).

Embodiment 68. The expandable foam formulation according to any of embodiments 61-67, wherein the one or more non-phenolic alcohols comprise one or more of tetrabromophthalic anhydride diol (2-(2-hydroxyethoxy) ethyl 2-hydroxypropyl 3,4,5,6-tetrabromophthalate), dibromoneopentyl glycol and tribromoneopentyl alcohol.

Embodiment 69. The expandable foam formulation according to any of embodiments 61-68, wherein the one or more non non-phenolic alcohols (e.g., flame-retardant alcohols) are present in a total amount up to 20 wt %, e.g., up to 15 wt %, or up to 10 wt %, or in the range of 1-20 wt %, or 1-15 wt %, or 1-10 wt %, or 2-20 wt %, or 2-15 wt %, or 2-10 wt %, or 5-20 wt %, or 5-15 wt %, or 5-10 wt %.

Embodiment 70. The expandable foam formulation according to any of embodiments 1-69, wherein the molar ratio of phenolic and non-phenolic alcohol-OH groups to epoxide groups of the one or more epoxy monomers is no more than 0.2:1, e.g., no more than 0.15:1 or no more than 0.1:1.

Embodiment 71. The expandable foam formulation according to any of embodiments 1-70, wherein the total amount of (meth)acrylate monomer(s), epoxy monomer(s), epoxy (meth)acrylate monomer(s), primary amine monomer(s), blowing agent, and, if present, phenols and/or non-phenolic alcohols in the expandable foam formulation material is at least 50 wt %, e.g., at least 60 wt %, at least 70 wt %, or at least 80 wt %.

Embodiment 72. The expandable foam formulation according to any of embodiments 1-71, further comprising a surfactant, e.g., in an amount up to 5 wt %.

Embodiment 73. The expandable foam formulation according to any of embodiments 1-72, wherein the expandable foam formulation further includes one or more non-alcoholic fire retardants.

Embodiment 74. The expandable foam formulation according to embodiment 73, wherein the one or more non-alcoholic fire retardants include a particulate fire retardant selected from melamine polyphosphate, ammonium polyphosphate, and expandable graphite.

Embodiment 75. The expandable foam formulation according to embodiment 73, wherein the one or more non-alcoholic fire retardants include one or more selected from organophosphorus compounds such as triethyl phosphate, tris(1,3-dichloroisopropyl) phosphate, resorcinol bis(diphenyl phosphate), (1-chloro-2-propyl) phosphate, 2,2-bis(chloromethyl) propane-1,3-diyl tetrakis(1-chloropropan-2-yl) bis(phosphate), tris (2-chloroethyl) phosphate, and 9-10-dihydro-9-oxa-10-phosphaphenanthrene-10-oxide (DOPO); and chlorinated paraffins.

Embodiment 76. The expandable foam formulation according to embodiment any of embodiments 73-75, wherein the one or more non-alcoholic fire retardants are present in an amount up to 40 wt %, e.g., up to 30 wt %, or up to 20 wt %, for example, in the range of 1-40 wt %, or 1-30 wt %, or 1-20 wt %, or 5-40 wt %, or 5-30 wt %, or 5-20 wt %, or 10-40 wt %, or 10-30 wt %, or 20-40 wt %.

Embodiment 77. The expandable foam formulation according to any of embodiments 1-76, further comprising one or more minerals having a dehydratable water content of at least 15 wt %.

Embodiment 78. The expandable foam formulation according to any of embodiments 1-76, further comprising one or more water-containing minerals having a dehydratable water content, the one or more minerals being selected from aluminum trihydrate (e.g., gibbsite), magnesium dihydrate, gypsum and magnesium carbonate hydrate.

Embodiment 79. The expandable foam formulation according to embodiment 77 or embodiment 78, wherein the one or more minerals are coated with a coating to enhance compatibility with the polymeric material of the foam (e.g., a hydrophobic coating).

Embodiment 80. The expandable foam formulation according to any of embodiments 77-79, wherein the one or more water-containing minerals are present in the expandable foam formulation in an amount in the range of 5-60 wt %, e.g., 5-45 wt % or 15-60 wt % or 15-45 wt % or 30-60 wt %.

Embodiment 81. The expandable foam formulation according to any of embodiments 1-80, wherein the expandable foam formulation includes no more than 500 ppm isocyanate (i.e., quantified on a weight basis as —NCO), e.g., no more than 100 ppm, or no more than 50 ppm.

Embodiment 82. The expandable foam formulation according to any of embodiments 1-81, wherein the expandable foam formulation is expandable to provide an expanded foam material, the expandable foam formulation having a maximum foam height; and a final peak pressure of no more than 1000 Pa, wherein for each local pressure maximum in excess of 50 Pa, a time difference between a time of the local pressure maximum and a time of 95% maximum foam height is no more than 100 seconds.

Embodiment 83. The expandable foam formulation according to any of embodiments 1-81, having a time of 95% maximum foam height of no more than 60 seconds, e.g., no more than 40 seconds, or even no more than 20 seconds.

Embodiment 84. The expandable foam formulation according to any of embodiments 1-83, having a tack-free time of no more than 5 minutes, e.g., no more than 4 minutes, or no more than 3 minutes.

Embodiment 85. A method for forming an expanded foam material, the method comprising causing the expandable foam formulation of any of embodiments 1-84 to expand and cure to form the expanded foam material.

Embodiment 86. The method of embodiment 85, wherein causing the expandable foam formulation to expand comprises allowing a volatile blowing agent of the expandable foam formulation to evaporate to form gas bubbles in the formulation.

Embodiment 87. The method of embodiment 85, wherein causing the expandable foam formulation to expand comprises allowing a chemical blowing agent of the expandable foam formulation to react to form gas bubbles in the formulation.

Embodiment 88. The method of embodiment 85, wherein causing the expandable foam formulation to expand comprises agitating the expandable foam formulation to create gas bubbles therein (e.g., wherein the expandable foam formulation lacks a blowing agent).

Embodiment 89. The method of embodiment 85, wherein causing the expandable foam formulation to expand comprises combining the expandable foam formulation with a stream of gas to create gas bubbles therein (e.g., wherein the expandable foam formulation lacks a blowing agent).

Embodiment 90. A method for providing a cavity with an expanded foam material, the cavity being enclosed by one or more walls including a first wall, the method comprising causing the expandable foam formulation of any of embodiments 1-84 to expand and cure to form the expanded foam material in the cavity.

Embodiment 91. The method of embodiment 90, performed as described in any of embodiments 85-89.

Embodiment 92. The method of embodiment 90 or embodiment 91, wherein the cavity is a building cavity, e.g., a wall cavity.

Embodiment 93. The method of embodiment 90 or embodiment 91, wherein the cavity is a cavity of a refrigerator or freezer, a cavity of a cooler or ice chest, or a cavity of a beverage container; a cavity in a vehicle, such as a car, a truck, an airplane or a boat (e.g., in a door or roof thereof); a cavity in a door (e.g., between skins of the door); or a cavity in a shell for a tub, such as a bathtub, a hottub or a spa.

Embodiment 94. The method according to any of embodiments 90-93, wherein the cavity has a first wall having an aperture formed therein, and wherein the expandable foam formulation is dispensed into the cavity from an insulation dispenser through the aperture.

Embodiment 95. The method according to any of embodiments 90-94, wherein the dispensing is performed in a plurality of discrete shots, so as to form multiple layers of expanded foam material in the cavity.

Embodiment 96. An expanded foam material that is the expanded and cured product of an expandable foam formulation of any of embodiments 1-84.

Embodiment 97. An expanded foam material that is made by the method according to any of embodiments 85-89.

Embodiment 98. An expanded foam material according to embodiment 96 or embodiment 97, having an average burn rate no more than 60 mm/min in the UL94 HBF test.

Embodiment 99. An expanded foam material according any of embodiments 96-98, having an R value of at least 2.0 per inch, e.g., at least 3.0 per inch, at least 3.5 per inch, at least 4.0 per inch, at least 5.0 per inch or at least 5.5 per inch.

Embodiment 100. A cavity enclosed by one or more walls, the cavity having an expanded foam material according to any of embodiments 96-99 disposed therein.

Embodiment 101. The cavity of embodiment 100, wherein the cavity is a building cavity, e.g., a wall cavity.

Embodiment 102. The cavity of embodiment 100, wherein the cavity is a cavity of a refrigerator or freezer, a cavity of a cooler or ice chest, or a cavity of a beverage container.

Embodiment 103. A kit for the provision of the expandable foam formulation according to any of embodiments 1-84 by the mixing of a first part with a second part, wherein the kit comprises
a first part comprising all of the one or more (meth)acrylate monomers, all of the one or more epoxy monomers, and all of the one or more epoxy (meth)acrylate monomers of the expandable foam formulation; and
a second part comprising all of the primary amine monomers of the expandable foam formulation,
wherein the first and second parts together comprise all components of the expandable foam formulation.

Embodiment 104. The kit according to embodiment 103, wherein the first part is provided in a first container, and the second part is provided in a second container.

Embodiment 105. The method according to any of embodiments 84-95, wherein causing the expandable foam formulation to expand and cure comprises
providing the kit of embodiment 103 or embodiment 104;
combining the first part and the second part to provide the expandable foam formulation.

Embodiment 106. The method according to embodiment 105, wherein the first part and the second part are combined in an insulation dispenser, and wherein the expandable foam formulation is dispensed from the insulation dispenser.

It will be apparent to those skilled in the art that various modifications and variations can be made to the processes and apparatuses described here without departing from the scope of the disclosure. Thus, it is intended that the present disclosure cover such modifications and variations of this invention provided they come within the scope of the appended claims and their equivalents.

1-20. (canceled)

21. An expandable foam formulation, the expandable foam formulation being expandable and curable to provide an expanded foam material, the expandable foam formulation comprising:
one or more (meth)acrylate and/or epoxy monomers, each selected from
one or more (meth)acrylate monomers,
one or more epoxy monomers, and
one or more epoxy (meth)acrylate monomers,
provided that if no epoxy (meth)acrylate monomer is present, both of one or more (meth)acrylate monomers and one or more epoxy monomers are present;
one or more primary amine monomers; and
optionally, a blowing agent,
wherein if no epoxy (meth)acrylate monomer is present, two or more of a (meth)acrylate monomer, an epoxy monomer and a primary amine monomer are polyfunctional.

22. The expandable foam formulation according to claim 21, wherein the one or more (meth)acrylate monomers comprise at least one polyfunctional (meth)acrylate monomer.

23. The expandable foam formulation according to claim 21, wherein the one or more (meth)acrylate monomers comprise one or more of a polyether poly(meth)acrylate monomer; a polyester poly(meth)acrylate monomer; a silicone poly(meth)acrylate monomer; a urethane poly(meth)acrylate monomers and/or a urea poly(meth)acrylate monomer.

24. The expandable foam formulation according to claim 1, wherein the one or more polyfunctional (meth)acrylate monomers are present in a total amount in the range of 10-80 wt %.

25. The expandable foam formulation according to claim 21, wherein the one or more epoxy monomers comprise at least one polyfunctional epoxy monomer.

26. The expandable foam formulation according to claim 21, wherein the one or more epoxy monomers are present in a total amount in the range of 10-80 wt %.

27. The expandable foam formulation according to claim 21, wherein no epoxy (meth)acrylate monomer is present.

28. The expandable foam formulation according to claim 21, wherein one or more epoxy (meth)acrylate monomers are present.

29. The expandable foam formulation according to claim 21, wherein the one or more epoxy (meth)acrylate monomers are present in a total amount in the range of 10-80 wt %.

30. The expandable foam formulation according to claim 21, wherein the one or more primary amine monomers comprise at least one polyfunctional primary amine monomer.

31. The expandable foam formulation according to claim 21, wherein the one or more primary amine monomers comprise a primary amine-bearing oligomer or polymer, for example, a polyethyleneimine.

32. The expandable foam formulation according to claim 21, wherein the one or more primary amine monomers are present in a total amount in the range of 5-50 wt %.

33. The expandable foam formulation according to claim 21, wherein the molar ratio of primary amine moieties of the one or more primary amine monomers to (meth)acrylate moieties of the one or more (meth)acrylate monomers and the one or more epoxy (meth)acrylate monomers in the expandable foam formulation is in the range of 3:1 to 1:1.5.

34. The expandable foam formulation according to claim 21, further comprising one or more one or more polyfunctional phenols, and/or one or more polyfunctional non-phenolic alcohols.

35. The expandable foam formulation according to claim 21, further comprising one or more minerals having a dehydratable water content of at least 15 wt %.

36. A method for forming an expanded foam material, the method comprising causing the expandable foam formulation of claim 21 to expand and cure to form the expanded foam material.

37. A method for providing a cavity with an expanded foam material, the cavity being enclosed by one or more walls including a first wall, the method comprising causing the expandable foam formulation of claim 21 to expand and cure to form the expanded foam material in the cavity.

38. The method of claim 37, wherein the cavity is a building cavity.

39. An expanded foam material that is the expanded and cured product of an expandable foam formulation of claim 21.

40. A kit for the provision of the expandable foam formulation according to claim 21 by the mixing of a first part with a second part, wherein the kit comprises
a first part comprising all of the one or more (meth)acrylate monomers, all of the one or more epoxy monomers, and all of the one or more epoxy (meth)acrylate monomers of the expandable foam formulation; and
a second part comprising all of the primary amine monomers of the expandable foam formulation,
wherein the first and second parts together comprise all components of the expandable foam formulation.
